(19) United States
(12) Patent Application Publication
(10) Pub. No.: US 2025/0136759 A1
(43) Pub. Date: May 1, 2025

(54) Structural Variants of 2D Polymers

(71) Applicant: MASSACHUSETTS INSTITUTE OF TECHNOLOGY, Cambridge, MA (US)

(72) Inventors: Michael S. STRANO, Lexington, MA (US); Yuwen ZENG, Allston, MA (US); Ge ZHANG, Cambridge, MA (US)

(21) Appl. No.: 18/836,707

(22) PCT Filed: Feb. 9, 2023
(86) PCT No.: PCT/US2023/062249

§ 371 Date: Aug. 7, 2024

Related U.S. Application Data
(60) Provisional application No. 63/308,292, filed on Feb. 9, 2022.

(51) Int. Cl. C08G 69/28; C08J 5/24; C08K 7/06

(52) U.S. Cl. CPC C08G 69/28; C08J 5/243; C08K 7/06; C08J 2377/06

(57) ABSTRACT

Structural variants of 2D polymers and composites thereof are described.

### CLAIM OF PRIORITY

This application claims priority to U.S. Provisional Patent Application No. 63/308,292, filed Feb. 9, 2022, which is incorporated by reference in its entirety.

### STATEMENT OF FEDERAL SUPPORT

This invention was made with government support under W911NF-18-2-0048 awarded by the Army Research Office (ARO). The government has certain rights in this invention.

### FIELD OF THE INVENTION

The invention relates to structural variants of 2D polymers.

### BACKGROUND

Polymers that extend covalently in two dimensions have been conceptualized for more than 85 years but their synthesis has remained elusive.

### SUMMARY

In one aspect, a composition can include a two dimensional polymer derived from at least:

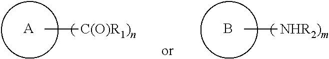

wherein R₁ is a leaving group and R₂ is H or C1-C6 alkyl, n is 2, 3, 4 or 5, m is 3, 4 or 5, and at least one of the A ring and the B ring is, independently, a planar symmetric ring.

In certain circumstances, n can be 3 and m can be 3, n can be 2 and m can be 3, n can be 3 and m can be 2, n can be 4 and m can be 2, or n can be 2 and m can be 4.

In certain circumstances, n can be 3, m can be 3, and the two dimensional polymer can include a structure

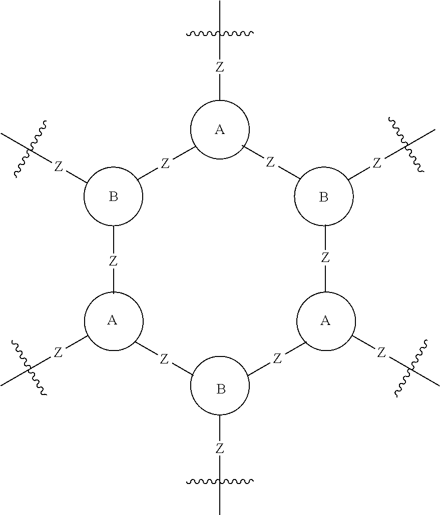

wherein each Z is an amide, urea, or carbamate linkage.

In certain circumstances, R₂ can be H.

In another aspect, a composition can include a two dimensional polymer derived from 5 one or more of the following planar building blocks:

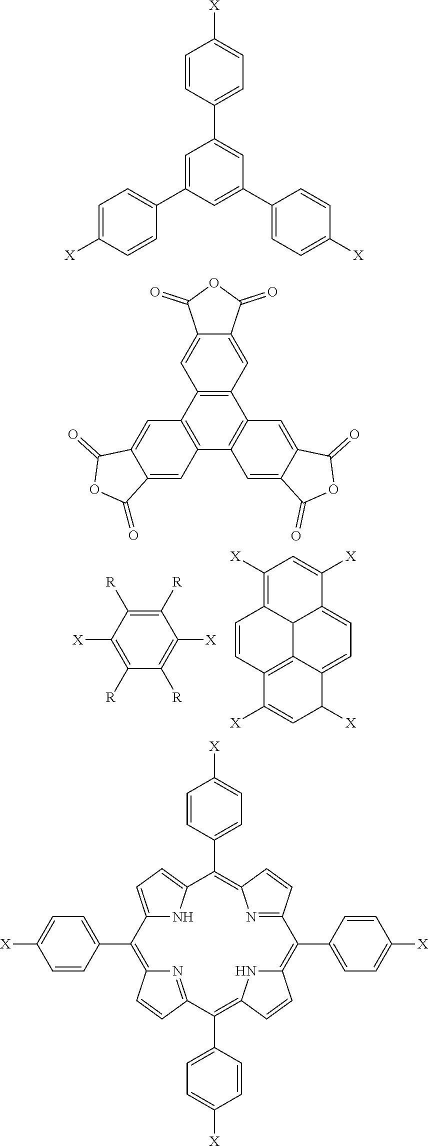

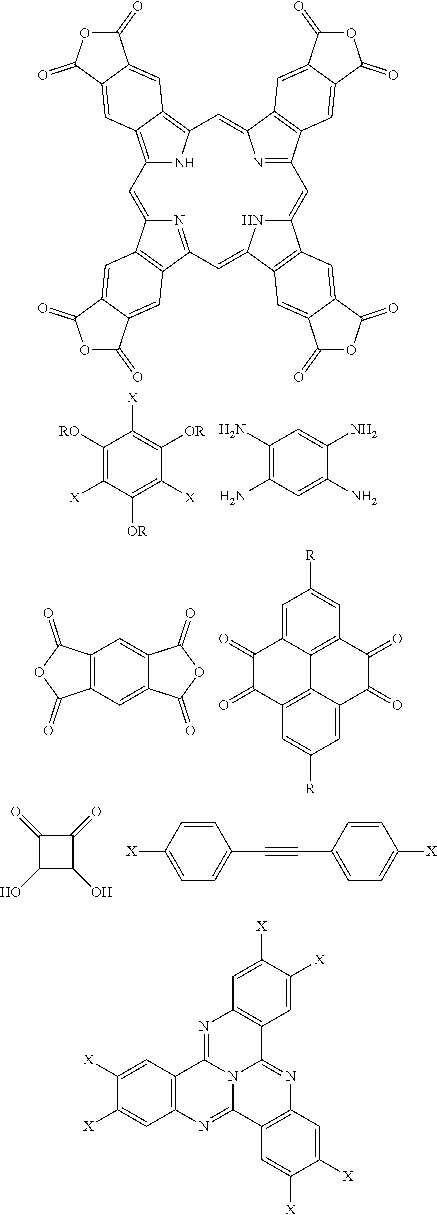

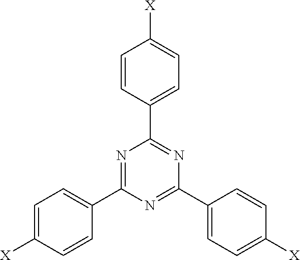

wherein each R, independently is H, C1-C6 acyl or C1-C6 alkyl and each X is an amino group, hydroxyl group, carboxyl group, anhydride group, or isocyanate group, wherein the X groups, anhydride groups or carbonyl groups of the building blocks bond to a polyamine building block to form the two dimensional polymer.

In certain circumstances, the polyamine building block can include a planar amine including at least three amine groups each of which forms an amide bond with one of the planar building blocks to form the two dimensional polymer.

In certain circumstances, the planar amine can include a tri-amino aryl group.

In certain circumstances, the aryl can be a carbocyclic aromatic or a heterocyclic aromatic.

In certain circumstances, the carbocyclic aromatic can be phenyl, naphthyl, antrhracenyl, phenanthrenyl, chrysenyl, pyrenyl, corannulenyl, triphenyl benzene, or coronenyl.

In certain circumstances, the heterocyclic aromatic can be pyridinyl, pyrimidinyl, triazinyl, pteridinyl, or a porphyrin.

In certain circumstances, the planar building block can include

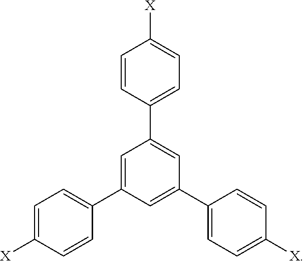

In certain circumstances, the planar building block can include

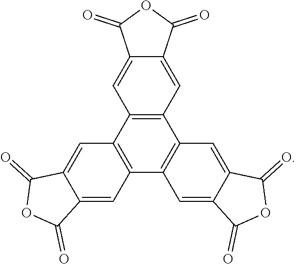 [SMILES: O=c1oc(=O)c2cc3c(cc12)c1cc2c(=O)oc(=O)c2cc1c1cc2c(=O)oc(=O)c2cc31]

In certain circumstances, the planar building block can include

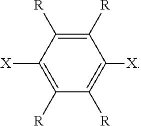

In certain circumstances, the planar building block can include

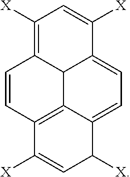

In certain circumstances, the planar building block can include

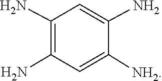

In certain circumstances, the planar building block can include

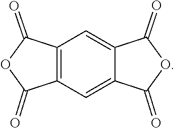 [SMILES: O=c1oc(=O)c2cc3c(=O)oc(=O)c3cc12]

In certain circumstances, the planar building block can include

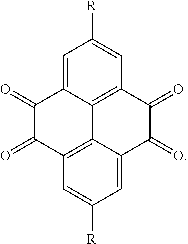

In certain circumstances, the planar building block can include

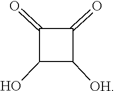

In certain circumstances, the planar building block can include

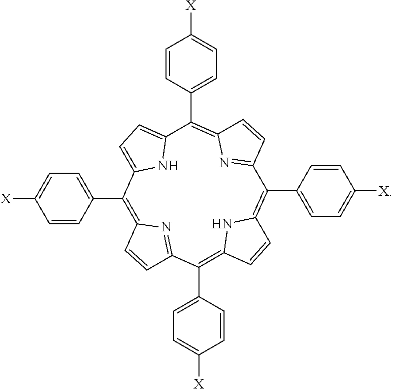

In certain circumstances, the planar building block can include

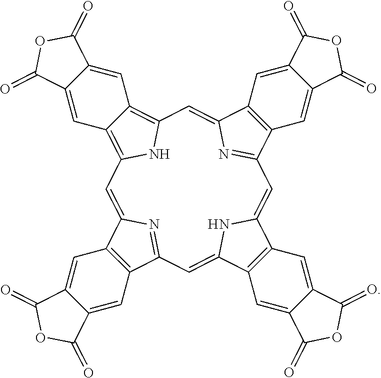 [SMILES: O=C1OC(=O)c2cc3c(cc21)-c1cc2[nH]c(cc4nc(cc5[nH]c(cc-3n1)c1cc3c(cc51)C(=O)OC3=O)-c1cc3c(cc1-4)C(=O)OC3=O)c1cc3c(cc21)C(=O)OC3=O]

In certain circumstances, the planar building block can include

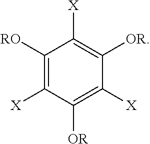

In certain circumstances, the planar building block can include

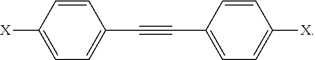

In certain circumstances, the planar building block can include

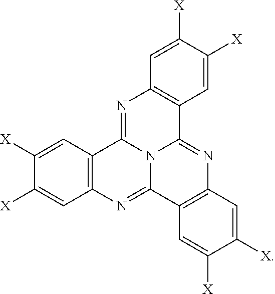

In certain circumstances, the planar building block can include

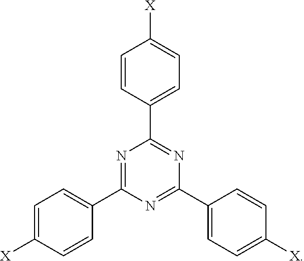

In another aspect, a method of manufacturing a composition described herein can include combining a planar building block with a polyamine building block to form the two dimensional polymer.

In another aspect, a method of forming a coating of a two dimensional polymer can include depositing a composition described herein on a surface.

In another aspect, a composite can include a composition described herein and a reinforcement material.

In certain circumstances, the reinforcement material can include a nanomaterial.

In certain circumstances, the nanomaterial can be a carbon nanotube, a graphene platelet or an alumina nanotube.

In certain circumstances, the reinforcement material can be graphene or carbon fiber.

In certain circumstances, the reinforcement material can be aligned.

In certain circumstances, the composite can be anisotropic.

In another aspect, a method of making a composite as described herein can include, comprising combining a two dimensional polymer with a reinforcement material.

In certain circumstances, the reinforcement material can be dispersed with a pre-polymer solution composed to form the two dimensional polymer.

In certain circumstances, a pre-polymer solution can be composed to form the two dimensional polymer is infused into the reinforcement material prior to polymerization.

In certain circumstances, the two dimensional polymer can be infused into an arrangement of the reinforcement material.

In certain circumstances, the arrangement of the reinforcement material can include aligned fibers or nanotubes.

In certain circumstances, the arrangement of the reinforcement material can include randomly oriented fibers or nanotubes.

Other embodiments are described below and are within the claims.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

In the figures:

FIGS. 1A-1I depict synthesis and characterization of a two-dimensional (2D) polymer.

FIGS. 2A-2H depict characterization of 2DPA-1 nanofilms.

FIGS. 3A-3K depict mechanical properties of films described herein.

FIGS. 4A-4E depict chemical kinetic theory of 2D polymerization.

FIGS. 5A-5C depict structural variations of 2D polymer motifs.

FIG. 6 depicts monomers for variants of 2D polymers.

FIG. 7 depicts a schematic of a laser induced particle impact test (LIPIT) apparatus.

FIGS. 8A-8C depict LIPIT image sequences showing impacts of silica particles (7.4 micron diameter) against films (˜300 nm thickness).

FIGS. 9A-9C depict real time and post-impact LIPIT images.

FIGS. 10A-10E depict LIPIT images and results.

FIGS. 11A-11C depict textured polymer nanocomposites and properties thereof.

FIG. 12 depicts a schematic of a composite.

### DETAILED DESCRIPTION

Solution phase synthesis can be used to produce two dimensional polymers as ultra-light weight, high strength materials. Two-dimensional polymers are described, for example, in U.S. patent application Ser. No. 16/919,051 and Zeng, et al., Nature, 2022, Vol. 608, p. 91, each of which is incorporated by reference in its entirety. They promise a unique combination of the high mechanical strength of layered materials such as graphene but with the low densities, synthetic processability, and control of composition of one-dimensional polymers. (Ref. 1) 2D irreversible polycondensation directly in the solution phase can result in covalently bonded 2D polymer platelets that are chemically stable and highly processable. Molecular simulation demonstrates that such new materials can achieve previously unattainable levels of mechanical strength per mass and area, and are highly promising for warfighter protection. Solution processing at preparative scales leads to highly oriented, large area free-standing films which exhibit exceptional 2D elastic modulus and yield strength already exceeding 50 GPa and 1.0 GPa, respectively. The relationships between organic composition and key mechanical properties in architectures can yield composite laminates with nano- and micro-fiber reinforcements to scroll fibers for new types of lightweight, high strength materials for multifunctional ballistic protection. The use of a specialized laser-based microparticle impact technique can uncover the role of platelet-platelet junctions in aligned material architectures that currently place an upper limit on performance. The central objective of the collaborative effort is to use mechanistic and molecular insight to extend these results towards the semi-infinite limit, and thereby realize the highest level of mechanical reinforcement and access new applications.

The synthesis, processing and structural applications of the two dimensional polymers is described that concatenate in bulk solution in two dimensions, forming distinctly two-dimensional platelets. This class of materials can access some of the highest levels of mechanical reinforcement and ballistic protection on an areal and mass basis. The two dimensional polymers represent a generation of ultra-lightweight structural materials and surfaces. The synthesis mechanism can lead to a terminal platelet size, forming intermolecular junctions that provide the upper limit of mechanical performance.

Chemical kinetic mechanisms of 2D polymerization in bulk solution and structural variants are described herein. Two mechanistic properties can be evaluated for their effects on platelet size. The in-plane to out-of-plane growth probability ratio (γ) is higher than unity because of amide conjugation. There is also a relative rate constant acceleration (β) from monomers adsorbed onto existing 2D platelets in what can be identified as auto-catalytic self-templating. Molecular variants are expected to have different mechanical properties.

Laser-based microparticle launch and imaging technique can permit direct measurement of the mitigation capabilities of materials prepared herein. The high-speed impacts can produce high strain rates (10⁶-10⁸ s⁻¹), and comparison to the results of quasi-static measurements described below can provide fundamental insights into the microscopic origins of the macroscopic mechanical properties as well as the mechanisms of mitigation and failure. The results can provide guidance for modeling of the dynamical behavior and for refinements of synthetic efforts for improved mitigation properties.

In addition, 2D polymers and the developed variations can be used in a nanocomposite using an exemplary nanofiber reinforcement (carbon nanotubes, CNTs) in both random and aligned orientations to create high packing fraction nanocomposites, with the goals of discovering hard nanostructure process-structure-property relations and linking to molecular and mechanistic understanding and complementing the high-strain-rate data.

Irreversible 2D polymerization without any 2D confinement is extremely untrivial because organic single bonds inside of the structure free rotate in 3D space, leading to enormous amount of twisty conformations. Although the in-plane 2D growth is entirely unfavored, it can still be realized using a number of strategies. The first one is to significantly reduce the energy barrier of in-planar growth by autocatalysis. Specifically, once negligible amount of 2D seeds are formed out of the very first random growth period, they serve as templates and guide monomers react on their 2D surfaces. This templating pathway can allow a rapid self-replication of 2D structures and therefore outcompete the random growth pathway. Another strategy is to diminish the entropy cost by rigidifying the whole reaction system, including aiming smaller nanopores with planar linkages, reducing degrees of freedom within the nanopore structure, and introducing hyperconjugations to help each segment keeps parallel with its neighbors. Hydrogen bonding can also have an impact.

In one aspect, a composition can include a two dimensional polymer derived from at least

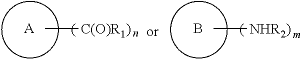

wherein R₁ is a leaving group and R₂ is H or C1-C6 alkyl, n is 2, 3, 4 or 5, m is 3, 4 or 5, and at least one of the A ring and the B ring is, independently, a planar symmetric ring. The symmetric ring can be a C3 or C4 symmetric ring. A C3 symmetric ring has a three-fold rotational axis perpendicular to the plane of the ring. A C4 symmetric ring has a four-fold rotational axis perpendicular to the plane of the ring.

In certain embodiments, the two dimensional polymer is derived from structures including ring A and ring B. The Lewis base sites on the aromatic ring in either monomer A or B can assist with overcoming solubility problems for the material.

A two dimensional material can be formed, for example, when n cis 3 and m is 3, n is 2 and m is 3, n is 3 and m is 2, n is 4 and m is 2 or n is 2 and m is 4.

In certain circumstances, n can be 3, m can be 3, and the two dimensional material can include a structure

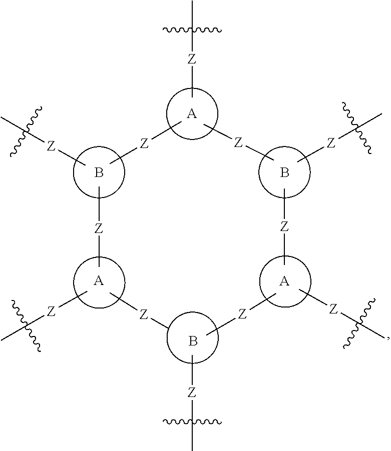

wherein each Z is an amide, urea, or carbamate linkage.

In certain circumstances, R₂ can be H.

Each ring can be an organic ring structure. Examples of 2D ring structures that could be modified to form the polymers described here can be found, for example, in Huang, et al., Nature Reviews Materials, Volume 1, October 2016, pages 1-19, which is incorporated by reference in its entirety.

In certain circumstances, the A ring can include a carbocyclic aromatic.

In certain circumstances, the carbocyclic aromatic can be phenyl, naphthyl, antrhracenyl, phenanthrenyl, chrysenyl, pyrenyl, corannulenyl, triphenyl benzene, or coronenyl.

In certain circumstances, the B ring can include a heterocyclic aromatic.

In certain circumstances, the heterocyclic aromatic can be pyridinyl, pyrimidinyl, triazinyl, pteridinyl, or a porphyrin.

In certain circumstances, before reaction, the A ring can be

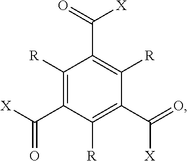

wherein R is H, halo, C1-C6 alkoxy or C1-C6 alkyl and X is a leaving group.

In certain circumstances, before reaction, the A ring can be

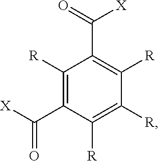

wherein R is H, halo, C1-C6 alkoxy or C1-C6 alkyl and X is a leaving group.

In certain circumstances, before reaction, the B ring can be

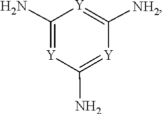

wherein each Y is, independently, N or CR₃, wherein R₃ is H, halo, C1-C6 alkoxy or C1-C6 alkyl.

In certain circumstances, X can be halo, hydroxyl, methoxy, or acetoxy.

In another aspect, a composition can include a two dimensional polymer derived from a planar building block. The two dimensional polymer can include one or more of the following building blocks:

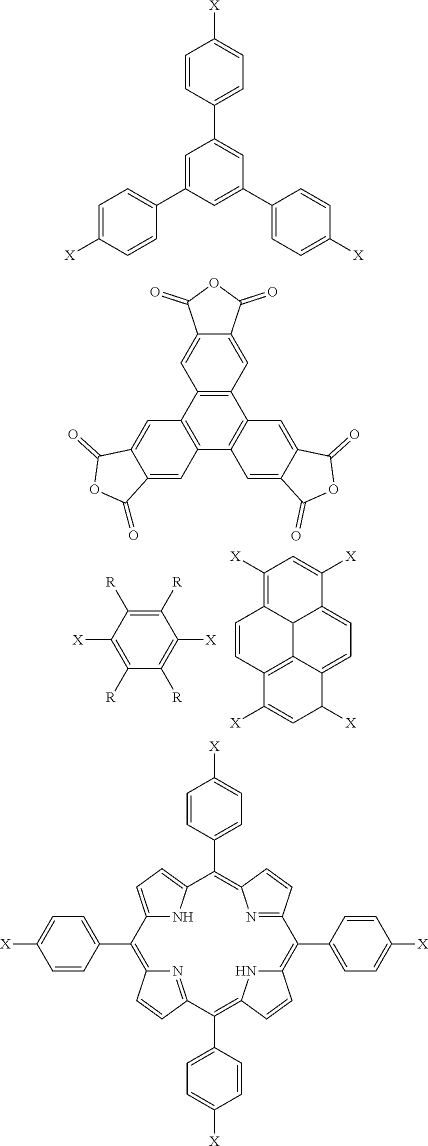

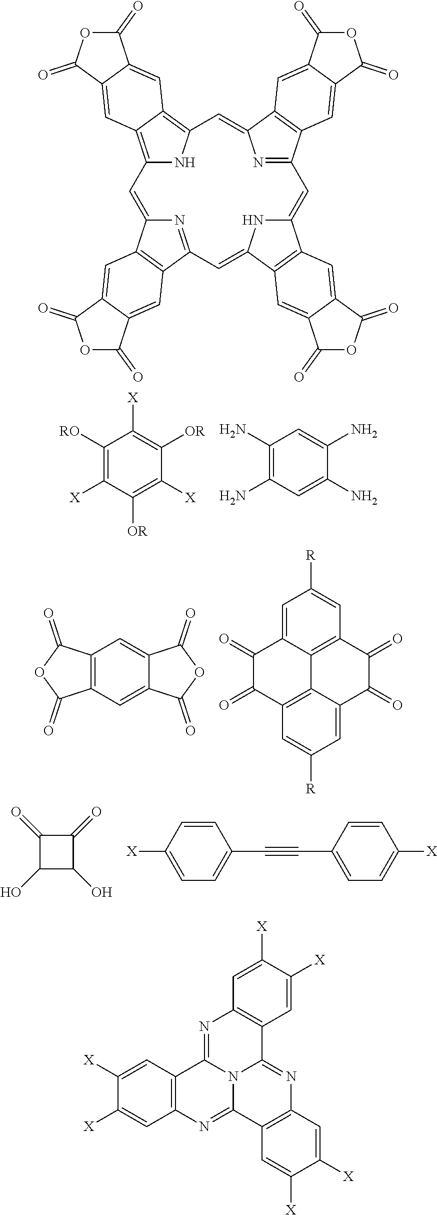

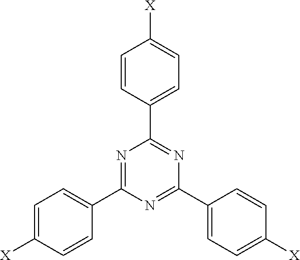

In these building blocks, each R, independently can be H, C1-C6 acyl or C1-C6 alkyl.

In the building blocks, each X can be an amino group, hydroxyl group, carboxyl group, anhydride group, or isocyanate group.

The two dimensional polymer can form through reaction of X groups, anhydride groups or carbonyl groups of the building blocks with a polyamine building block.

In certain circumstances, the polyamine building block can include a planar amine including at least three amine groups each of which forms an amide bond with one of the planar building blocks to form the two dimensional polymer. For example, the planar amine can include a tri-amino aryl group.

In certain circumstances, the aryl can be a carbocyclic aromatic or a heterocyclic aromatic. For example, the carbocyclic aromatic can be phenyl, naphthyl, antrhracenyl, phenanthrenyl, chrysenyl, pyrenyl, corannulenyl, triphenyl benzene, or coronenyl. In another example, the heterocyclic aromatic is pyridinyl, pyrimidinyl, triazinyl, pteridinyl, or a porphyrin.

In certain circumstances, a planar building block can include

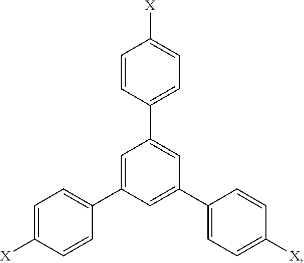

where each X is an amino group, hydroxyl group, carboxyl group, anhydride group, or isocyanate group. Preferably, each X is the same.

In certain circumstances, the planar building block can include

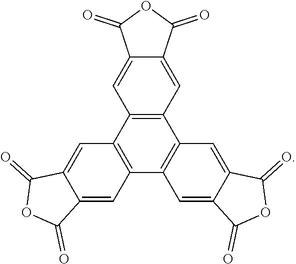 [SMILES: O=c1oc(=O)c2cc3c(cc12)c1cc2c(=O)oc(=O)c2cc1c1cc2c(=O)oc(=O)c2cc31]

In certain circumstances, the planar building block can include

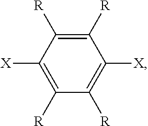

where each X is an amino group, hydroxyl group, carboxyl group, anhydride group, or isocyanate group. Preferably, each X is the same. Each R, independently is H, C1-C6 acyl or C1-C6 alkyl. Preferably, each R is the same.

In certain circumstances, the planar building block can include

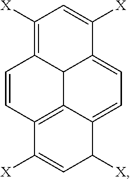

where each X is an amino group, hydroxyl group, carboxyl group, anhydride group, or isocyanate group. Preferably, each X is the same.

In certain circumstances, the planar building block can include

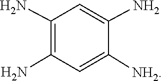

In certain circumstances, the planar building block can include

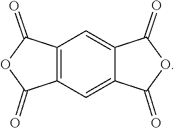 [SMILES: O=c1oc(=O)c2cc3c(=O)oc(=O)c3cc12]

In certain circumstances, the planar building block can include

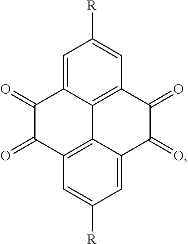

where each R, independently is H, C1-C6 acyl or C1-C6 alkyl. Preferably, each R is the same.

In certain circumstances, the planar building block can include

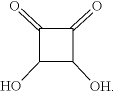

In certain circumstances, the planar building block can include

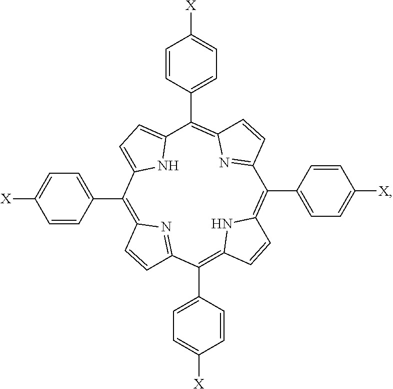

where each X is an amino group, hydroxyl group, carboxyl group, anhydride group, or isocyanate group. Preferably, each X is the same.

In certain circumstances, the planar building block can include

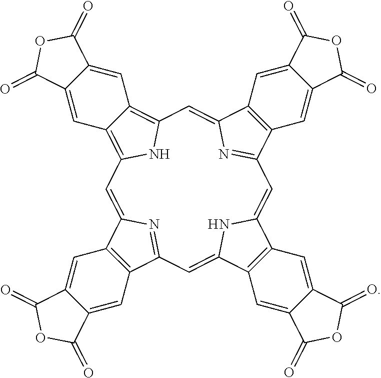 [SMILES: O=C1OC(=O)c2cc3c(cc21)-c1cc2[nH]c(cc4nc(cc5[nH]c(cc-3n1)c1cc3c(cc51)C(=O)OC3=O)-c1cc3c(cc1-4)C(=O)OC3=O)c1cc3c(cc21)C(=O)OC3=O]

In certain circumstances, the planar building block can include

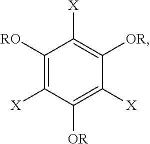

where each X is an amino group, hydroxyl group, carboxyl group, anhydride group, or isocyanate group. Preferably, each X is the same.

In certain circumstances, the planar building block can include

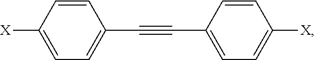

where each X is an amino group, hydroxyl group, carboxyl group, anhydride group, or isocyanate group. Preferably, each X is the same.

In certain circumstances, the planar building block can include

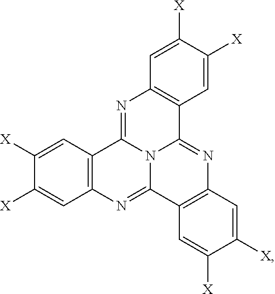

where each X is an amino group, hydroxyl group, carboxyl group, anhydride group, or isocyanate group. Preferably, each X is the same.

In certain circumstances, the planar building block can include

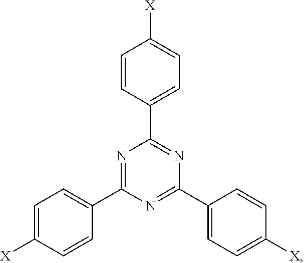

where each X is an amino group, hydroxyl group, carboxyl group, anhydride group, or isocyanate group. Preferably, each X is the same.

In certain circumstances, the material includes a plurality of the structure. In other words, the material includes a two-dimensional network including repeating units of the structure.

In certain circumstances, the material can have an in-plane structure. In certain circumstances, the material can have an out-of-plane structure. The in-plane structure is a structure in which the angle of the amide or other polar bonds are relatively small, for example, may be less than 30 degree. The out-of-plane structure is a structure having the amide or other polar bonds out of the plane of the ring structures. The out-of-plane structure can create high density of interlayer hydrogen bonds in the structure and thus have enhanced mechanical properties.

In another aspect, a method of manufacturing a composition described herein can include combining a planar building block with a polyamine building block to form the two dimensional polymer.

In certain circumstances, the combining takes place in a solvent selected from trifluoroacetic acid (TFA), trifluoroethanol (TFE), N-methyl-2-pyrrolidone (NMP), 1,3-dimethyl-2-imidazolidinone (DMI), N,N′-dimethylpropyleneurea (DMPU), or hexamethylphosphoramide (HMPA) and salt solutions thereof. The salt can be a Lewis Acid, such as calcium chloride or lithium chloride.

The reaction conditions are important in determining whether the in-plane or out-of-plane structure is created. This is the case, in part, because the reaction is kinetically controlled. This selectivity can be important because in order to get strong interlayer hydrogen bonding, the amide bonds need to orient out of the molecular plane, and the out-of-plane structure is actually energetically unfavored compared to the in-plane structure. The energy difference is large (˜70 Kcal/nanopore), making the achievement of the out-of-plane structure surprising. A common feature of those solvents is they are strong Lewis bases thus can serve as great hydrogen bond acceptors. Additives can also enhance the synthesis. The salts such as CaCl₂), LiCl and others are Lewis acids here, can help to dissolve the 2D molecules and also facilitate this reaction. Solubility is important because once the 2D polymer molecule leave the reaction system, it stops growing. According to simulation, the strength of bulk material has a strong correlation with the molecular size.

In another aspect, a method of forming a coating of a two-dimensional material can include depositing a material described herein on a surface. The coating can be formed by spin coating, dip coating or drop coating the material on the surface, for example, in a solution. The solvent can be polar and protic, for example, an acid such as trifluoroacetic acid (TFA).

In another aspect, a composite can include a two dimensional polymer described herein and a reinforcement material. The two dimensional polymer can form a matrix that includes the reinforcement material. The composite can be a reinforced film.

In certain circumstances, the reinforcement material can include a nanomaterial, for example, a carbon nanotube, a graphene platelet or an alumina nanotube. The nanomaterial can be aligned or oriented relative to a surface. Alternatively, the nanomaterial can be randomly placed and not aligned.

In certain circumstances, the reinforcement material can include graphene or carbon fiber.

In certain circumstances, the composite is anisotropic. In an anisotropic composite, physical properties in one dimension can differ from physical properties in another dimension. For example, properties along the length of the material differ from properties along the thickness of the material.

In another aspect, a method of making a composite described herein can include combining a two dimensional polymer with a reinforcement material.

For example, the reinforcement material is dispersed with a pre-polymer solution composed to form the two dimensional polymer. The pre-polymer solution can include monomers corresponding to at least the planar building block, which then polymerize with other components to form the two dimensional polymer.

In another example, a pre-polymer solution composed to form the two dimensional polymer can be infused into the reinforcement material prior to polymerization.

In another example, the two dimensional polymer can be infused into an arrangement of the reinforcement material. In this case, the two dimensional polymer can be dissolved in a solvent and deposited on the reinforcement material.

When making a composite, the arrangement of the reinforcement material can include aligned fibers or nanotubes or randomly oriented fibers or nanotubes.

The two dimensional polymer can be deposited to form a film. The film can have a thickness of 5 nm, 10 nm, 15 nm, 20 nm, 25 nm, 30 nm, 35 nm, 40 nm, 45 nm, 50 nm, 55 nm, or 60 nm. The thickness can be less than 10 microns, less than 5 microns, less than 1 micron, less than 100 nm, less than 90 nm, less than 80 nm or less than 70 nm. The film can be substantially uniform in thickness.

The two dimensional polymer can be formed into a scroll. The scroll can have a diameter of less than 10 microns, less than 5 microns, less than 1 micron, less than 100 nm, less than 90 nm, less than 80 nm or less than 70 nm.

Two-dimensional polymers have long been conceptualized, and attempts as early as 1935 explored one-dimensional concatenation of amphiphiles confined to air-water interfaces. (Refs 2 and 3) This work by Gee and co-workers inspired recent advances towards 2D polymers utilizing surface templates in the work of Stupp (Ref. 4) and Ozaki (Ref. 5), promising strategies that might allow the release of such materials from the template in a scalable fashion. (Ref. 6) Similarly, Cote and co-workers first synthesized two covalent organic frameworks (COFs)—which entail reversible solvothermal crystallization—that showed layered unit cells stacked in 3D. (Ref. 7) This and variants, however, have proven difficult to exfoliate or reprocess into engineering materials with useful properties. Reversible synthetic approaches appear to yield materials with limited chemical and mechanical stability such that exfoliation or isolation is difficult (Refs. 8 and 9) A substantial advance came about recently by utilizing irreversible nucleophilic aromatic substitutions for 2D polycondensation under solvothermal conditions. (Refs. 10 and 11) The resulting bulk powders, unlike previous examples, are chemically stable-pointing to the importance of irreversible bonding in approaching the properties of 1D polymer systems. In contrast, Chemical Vapor Deposition (CVD) has enabled access to a substantial number of 2D crystalline materials such as graphene, dichalcogenides, and hexagonal boron nitride (Ref. 12), with extraordinary in-plane mechanical properties approaching that of diamond. Refs. 13 and 14) The high temperatures typically needed for CVD exclude polymerization of organic molecules, and hence, 2D organic analogs of 1D polymers have thus far remained elusive. The totality of this prior work points to the importance of irreversible chemical routes, necessarily outside of solvothermal or CVD synthetic methods, with in-plane bonding such that solution-phase exfoliation is possible.

There are several challenges to 2D polymerization directly in bulk solution, but the most fundamental is that for a 2D disk molecule, the number of perimeter addition sites scales with the number of incorporated monomers i to the ½ power. For the 3D spherical counterpart, however, it grows much faster with ⅔ power. This means that as soon as a polymerizing molecular disk grows a defect branch out of the plane, the 3D structure can extend much faster than the desired in-plane 2D disk. Such out-of-plane branches occur easily, with just a single bond rotation of an attached monomer. It is clear that 2D polymerization must fundamentally overcome the high entropic cost of maintaining in-plane bonding. Worst still, irreversible synthetic routes necessarily magnify the impact of single out-of-plane defects with no means of error-correcting. (Ref. 15)

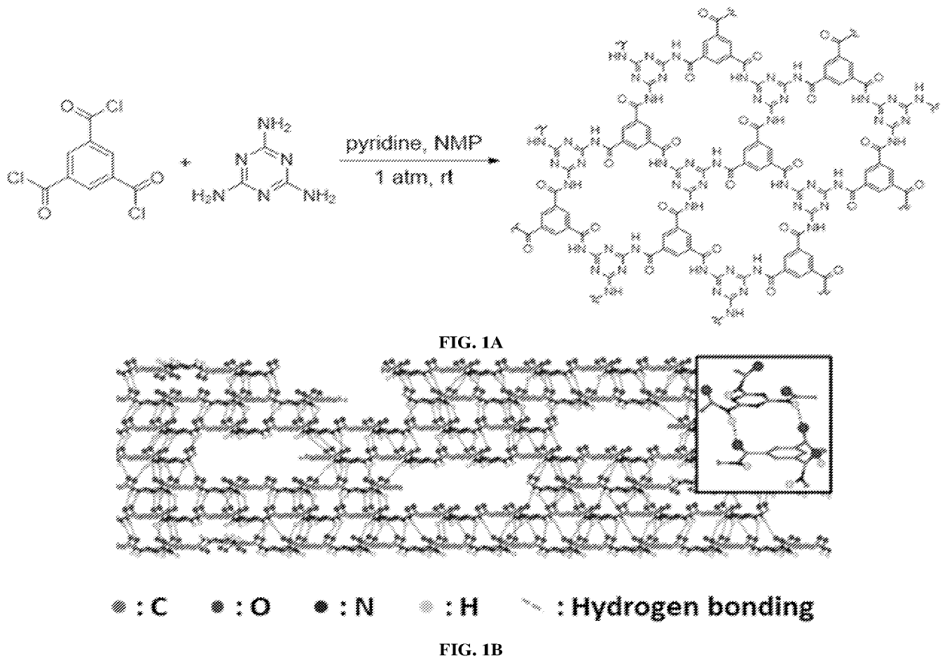

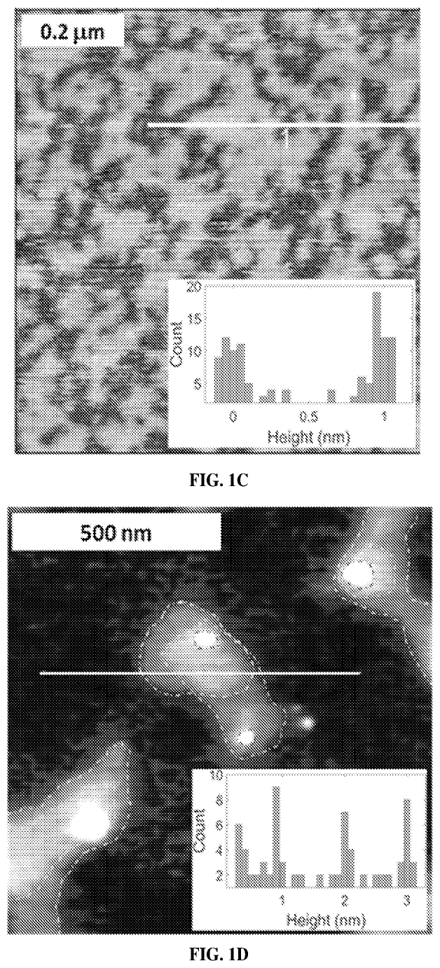

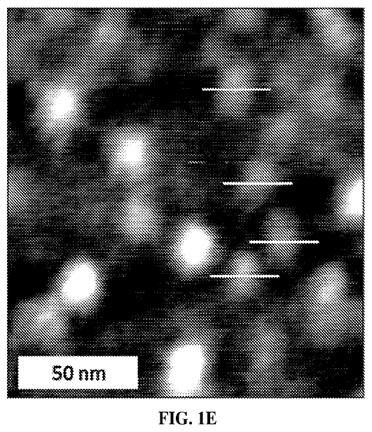

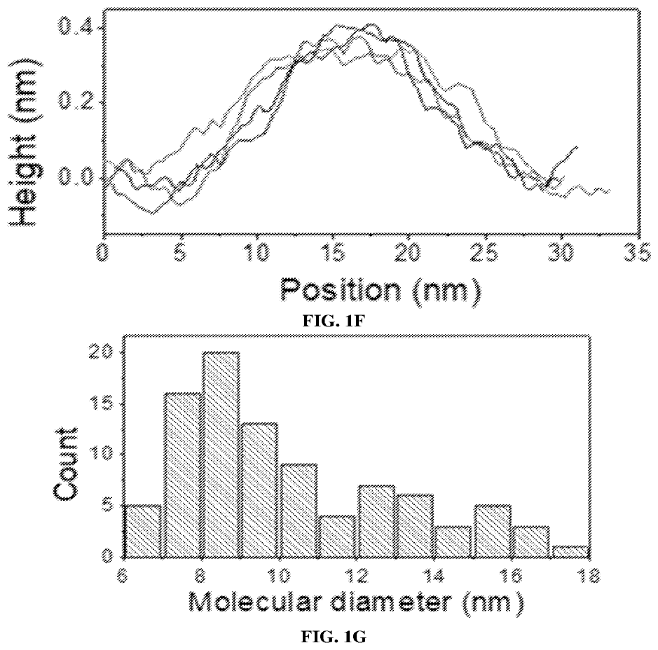

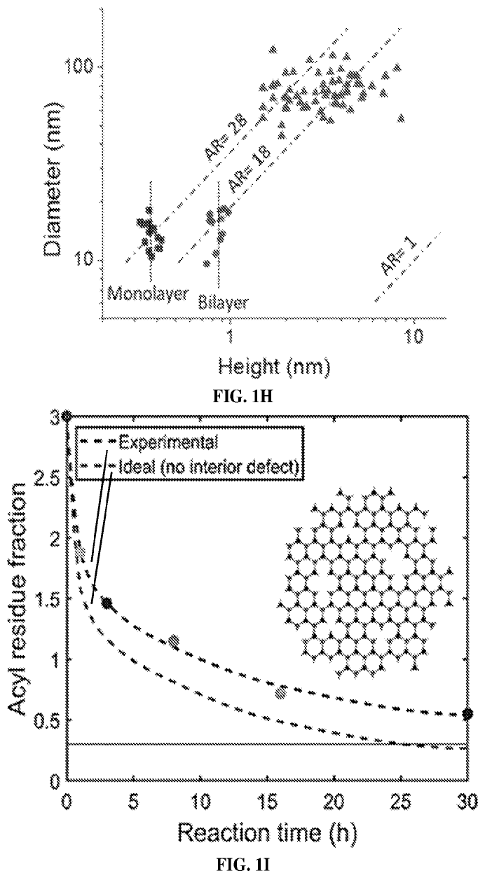

Our strategy in designing a synthetic approach to overcome these challenges is multifold, and involves an amide condensation of C3-symmetric acid chloride and melamine (FIG. 1A). One hypothesis is that a strong amide-aromatic conjugation inhibits out-of-plane rotation, meanwhile, the interlayer hydrogen bonding or van der Waals attraction can allow growing disks to absorb monomers from the solution phase and auto-template them onto 2D surfaces, facilitating the 2D growth pathway. Indeed, chemical kinetic modeling shows that it is possible to produce 2D polymers in excess of 90% yield with a combination of a moderate in-plane to out-of-plane probability ratio (γ) expected from amide conjugation, along with a relative rate constant acceleration (β) from monomers adsorbed onto existing 2D platelets as a form of auto-catalytic self-templating. In the designed reaction system, the inert amide linkage ensures superb mechanical and chemical stability, allowing sonication, harsh acid or heat treatment. Additionally, triazine cores are intentionally introduced into the structure (FIG. 1A) and offer a high density of Lewis bases, leading to protonation in strong acid and thus excellent solubility in such solvents for high processability.

A major challenge in the design and fabrication of ultra lightweight 2D materials is to achieve high strength for mitigation of particle impact and of shock or blast waves. One of the impediments to improved performance is the difficulty in conducting adequate tests of new 2D materials, especially in the early stages of development prior to synthetic scale-up when only small quantities of material may be available. Samples at that stage may have extremely small lateral dimensions, submillimeter if not sub-100-microns, in addition to submicron thickness. High-strain-rate testing of such samples could provide fundamental insights that would guide modeling and further steps in design and synthesis without ever needing more extensive (and often far more difficult and time-consuming) fabrication efforts. A recently developed method, the laser-induced particle impact test (LIPIT) (Refs. 16-21) permits high-speed microparticle impact testing on extremely small-scale samples as illustrated subsequently. Imaging of the laser-launched microparticle on its way toward the sample and after transmission through or rebounding from the sample permits determination of the particle velocities and from them the particle energy that is dissipated during impact. Close-up viewing of the impact in real time and post-impact analysis of the sample provide additional insights into the sample response including mitigation or failure mechanisms. The measurements can therefore provide a key component in an iterative program of material design, synthesis, testing, and modeling, all at a highly accelerated rate because of the small sample sizes (<100 μm×100 μm×0.1 μm, or <10 nanogram, for a single measurement) that can be tested. Measurements conducted on samples with varying extents of platelet-platelet hydrogen bond linkages as well as different in-plane structural motifs can reveal the roles these features play in macroscopic properties. Further insight can be gained through comparison between the results of the LIPIT measurements, with strain rates in the 10⁶-10⁸ s⁻¹ range, and quasistatic measurements. The comparison can reveal the effects of dynamical relaxation due to hydrogen bond breakage and reformation and other degrees of freedom on high-strain-rate mitigation, providing further guidance to improved material design.

2D polyaramide can be referred to as 2DPA-1. Nanocomposites and layered-nanocomposite architectures comprising the new 2DPA-1 material need to be further explored as part of establishing the engineering materials base of understanding for this new class of compounds. How can nanocomposites be made and affect 2DP morphology and structure-property relations to link 2DP structure, both neat (2DP and its emerging variants) and as a nanocomposite, to standard mechanical properties such as stiffness, strength, and toughness? Of particular interest and importance is studying directional properties given that the 2DP as well as the nanocomposite can be textured (nanofibers with random and aligned carbon nanotubes, CNTs). A unique capability includes facile processes for maintaining nanofiber alignment in bulk and thin-film orientations while varying nanofiber packing fraction continuously and to beyond packing fractions that exceed 30 vol %, allowing synthesis, processing, and characterization of composites with directional properties. For example, recent work with ARL has revealed strong and nonlinear confinement effects on polyurethane-urea (PUU) in nanocomposites between 10-20 vol % aligned CNT packing in which the inter-CNT spacing is ˜10 nm, where unique hard and soft segment segregation and size distribution is achieved. A variety of processing routes exist for the 2DP and nanofibers as described below, and similarly depending on scale, a variety of experimental techniques can probe properties of different composite architectures (2DP-based fibers, thin films and bilayers, and bulk 3D materials such as aligned nanofiber 2DP polymer nanocomposites). Scanning probe microscopy via AFM and nanoindentation are two primary property measurement techniques compatible with the envisioned neat and composite architectures, and are complemented with characterization tools such as XRD, WAXD/SAXS and TEM (including 3D TEM, to elucidate possible 2DP-CNT interactions). AFM and nanoindentation can be used to assess anisotropy utilizing different sample preparation vectors, and the resulting quasi-static properties of modulus and hardness can allow comparison to high-strain results and therefore contribute a rich mapping of structure to properties, all providing feedback on synthesis.

Synthesis and chemical kinetics focus on elucidating the chemical kinetic mechanisms involved in 2D polymerization in bulk solution, improving the synthesis route and product size of 2D polymer, and exploring structural variants. The current synthesis route and some AFM characterization results of 2D polyaramid (2DPA-1) are shown in FIG. 1A. Single-atom-thick 2D platelets are acquired via a facile solution-phase reaction (FIGS. 1D-1F).

FIG. 1A shows a synthetic route to 2D polyaramid, termed 2DPA-1, where NMP is N-methyl-2-pyrrolidone. FIG. 1B shows a cross-sectional view of a proposed hydrogen-bonded, interlocked layered structure. A close-up of interlayer hydrogen bonds is shown in the inset. FIG. 1B is an atomic force microscopy (AFM) image of bilayer nanoclusters and its height histogram along the white line (inset). FIG. 1D is an AFM image of stacked nanosheets, the inset showing the height histogram along the white line. FIG. 1E is a high-resolution AFM image of TMS-2DPA-1. White dots are bilayer aggregates. Height profiles along white lines are shown in FIG. 1F. FIG. 1G shows a size distribution of individual TMS-2DPA-1 molecules. FIG. 1H shows a plot of diameter against height for monolayers (squares) and bilayers (dots) from TMS-2DPA-1, as well as 2DPA-Am (triangles, amorphous counterpart of 2DPA-1, obtained when trimesoyl chloride is replaced by isophthaloyl chloride under standard conditions). Dotted lines represent shapes with certain aspect ratios. FIG. 1I shows acyl residue fraction versus reaction time. Blue horizontal line is the limit of residue fraction when molecules grow infinitely large, corresponding to the interior defect density. A representative 2DPA-1 molecule is given in the middle.

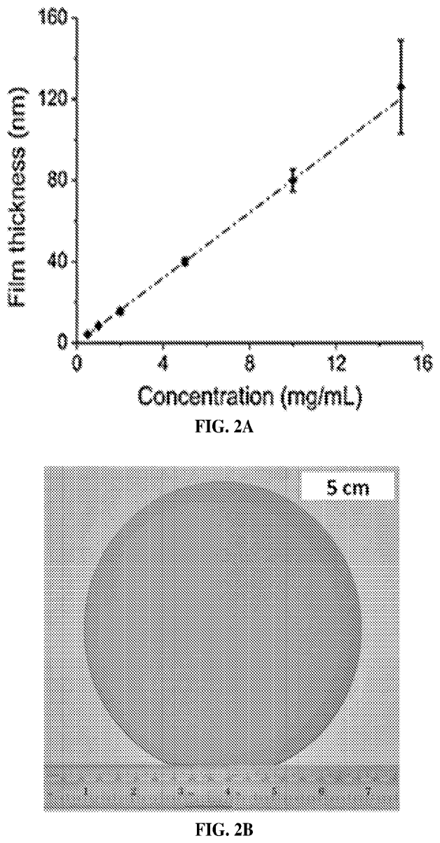

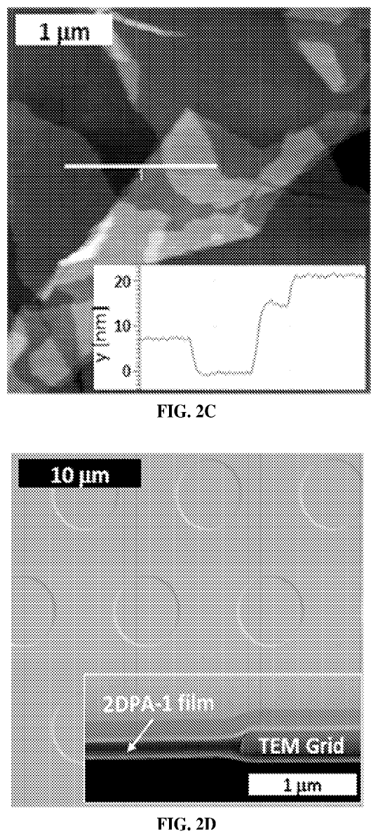

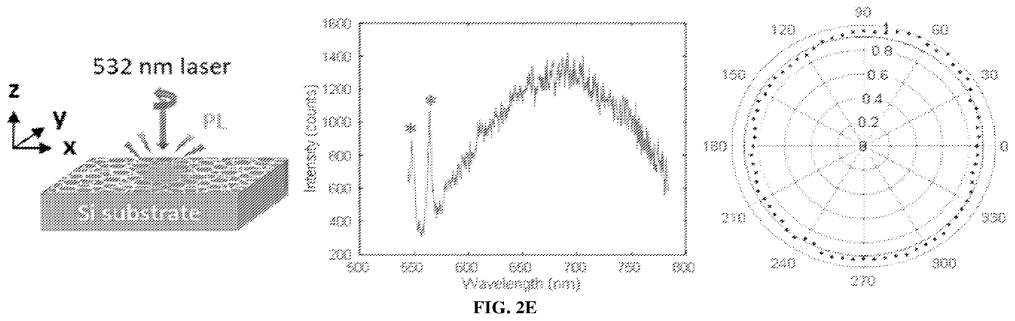

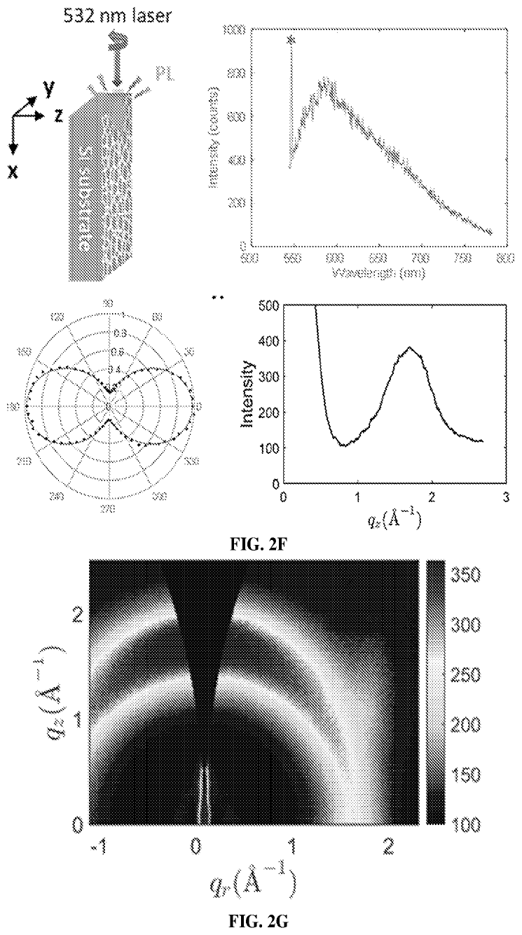

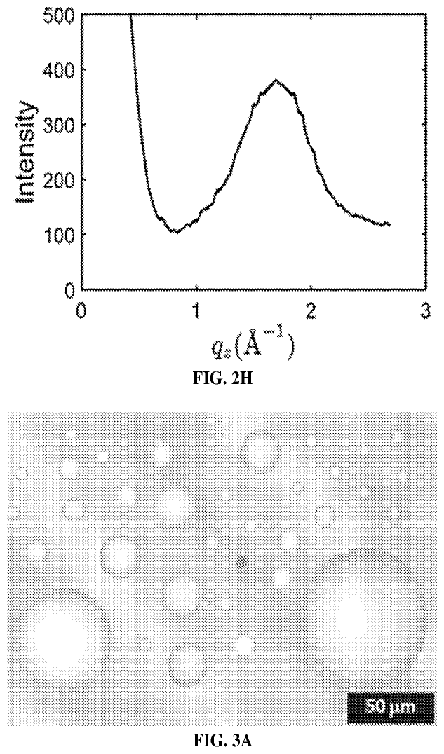

The purified 2D polymer can be dissolved in acid and spin-coated to form a highly-uniform, large-area film with a thickness of tens of nanometers (FIGS. 2A-2C). The molecules are oriented parallel to the substrate in the film, as evidenced by the polarized Raman spectrum and GIWAXS (FIGS. 2E-2H).

FIG. 2A is a graph showing the thickness versus concentration dependence of spin-coated 2DPA-1 films on SiO₂ covered (300 nm) silicon wafers. Confidence intervals are shown as error bars. FIG. 2B shows a 6-inch transferred 2DPA-1 film on a SiO₂/Si wafer. FIG. 2C shows an atomic force microscopy (AFM) image of a transferred 2DPA-1 nanofilm at film edges near which cracks, wrinkles, and folds are observed. The inset shows the height profile along the white line. FIG. 2D shows scanning electron microscopy (SEM) images of a suspended 2DPA-1 film on a Si₃N₄ TEM Grid. The inset shows a cross-sectional view of a hole after focused ion beam (FIB) cutting. FIG. 2E shows a top view photoluminescence (PL) measurement of a 2DPA-1 nanofilm at 532 nm excitation. The image on the left is a schematic illustration. The graph in the middle is a PL spectrum, where Si Raman peaks at 550 and 570 nm are labeled with “*”. The image on the right is a polar plot of the top view, where the fitting curve intensity is 0.91 of maximum. FIG. 2F is a side view photoluminescence (PL) measurement of a 2DPA-1 nanofilm at 532 nm excitation. The image on the left is a schematic illustration. The image in the middle is a PL spectrum, where the Si Raman peak at 550 nm is labeled with “*”. The image on the right is a polar plot of the side view. The fitting curve intensity is 0.1452±0.8365*cos 2θ. FIG. 2G shows a grazing-incidence wide-angle X-ray scattering (GIWAXS) 2D image, and its 1D intensity profile (FIG. 2H) near qᵣ=0 A⁻¹ of the 2DPA-1 film.

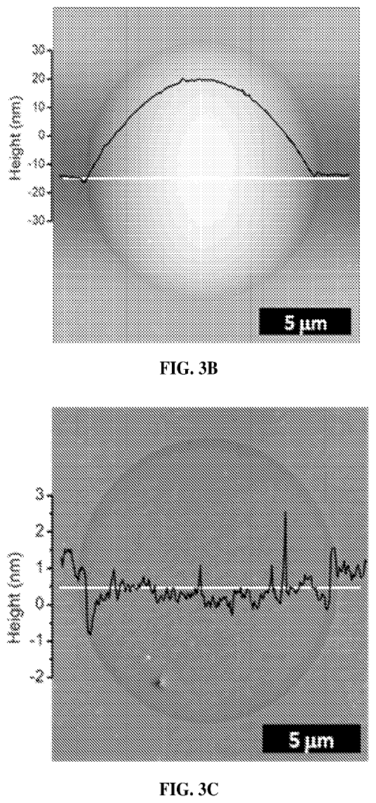

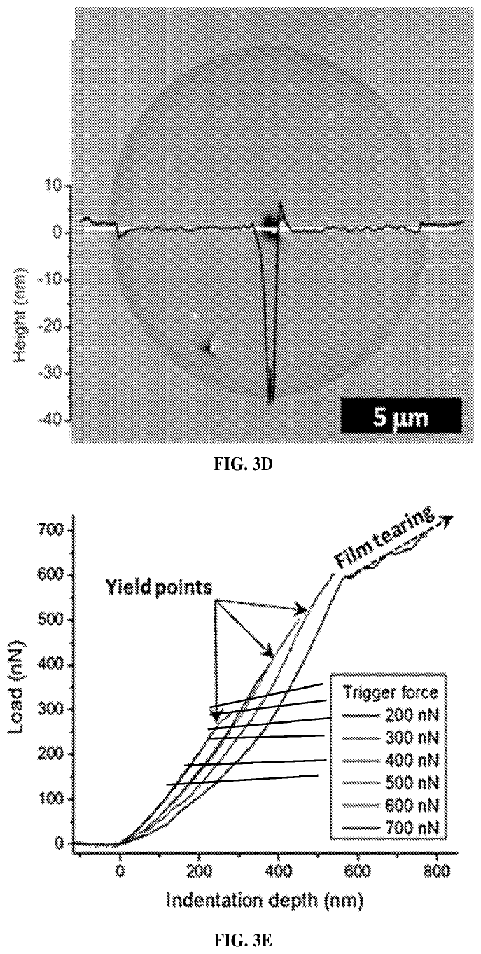

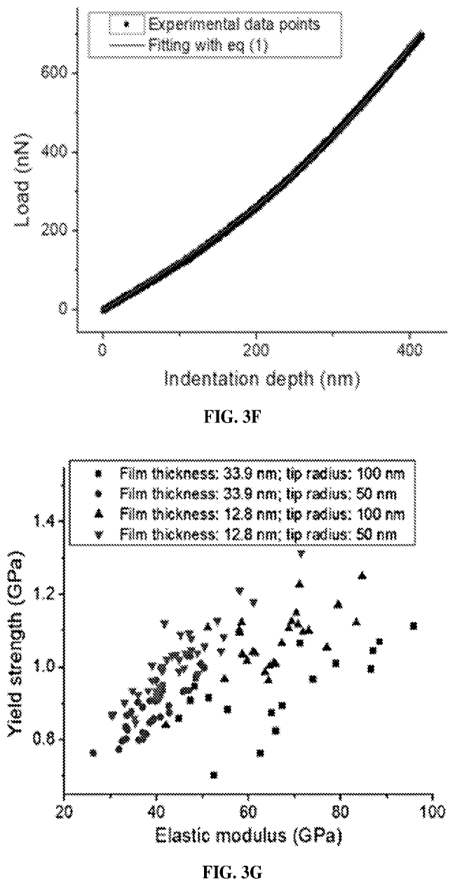

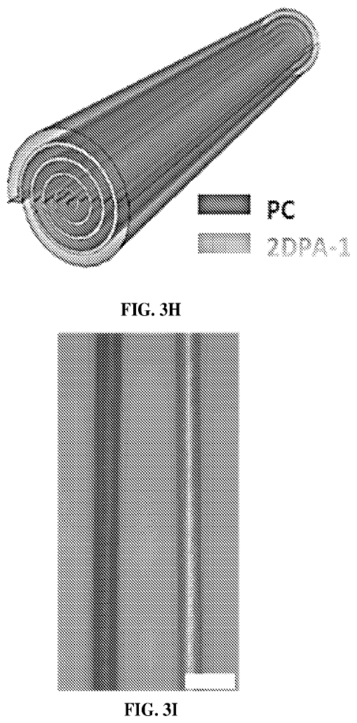

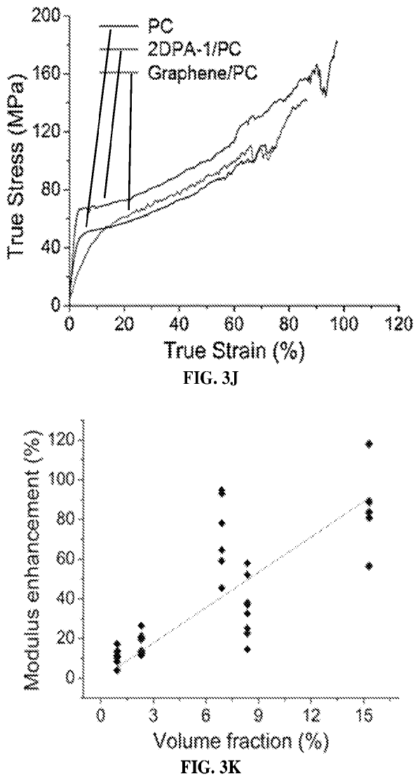

The strong interlayer hydrogen bonding gave rise to an exceptional mechanical strength of free-standing 2DPA-1 film (FIGS. 3A-3D). AFM indentation revealed outstanding 2D elastic modulus and yield strength at 50.9±15.0 GPa and 0.976±0.113 GPa, respectively (FIGS. 3E-3G).

FIG. 3A shows an optical micrograph of a 33.9-nm thick 2DPA-1 film on a Si holey substrate. White circles are intact membranes and the black dot in the middle represents a fractured membrane. FIG. 3B shows a 13.7-μm SiO₂/Si well covered by a 12.8-nm thick 2DPA-1 film forming an impermeable bubble of trapped gas as shown by the AFM height profile (along the white line). FIG. 3C shows a collapsed membrane after puncturing with an AFM tip and subsequent gas release, showing a flat height profile (along the white line). The small pinhole is located in the lower left. FIG. 3D shows a membrane after indenting and its height profile along the white line. FIG. 3E shows an indentation on a 12.8-nm thick, 13.2-μm wide free-standing membrane at its center with successively increasing trigger forces. The tip radius was 100 nm. Curve overlapping proves its elasticity and a right-shift of the curve indicates plastic deformation has occurred in the previous run. FIG. 3F shows a representative force-displacement curve and its modulus fitting. Conditions were a 33.9-nm thick, 24.7-μm wide membrane with a 100-nm radius tip. FIG. 3G shows a plot of 2D elastic modulus against its 2D yield strength of 2DPA-1. FIG. 3H shows a schematic illustration of an Archimedean scroll fiber. FIG. 3I shows an optical micrograph of a hair (left) and a scrolled fiber (right), where the scale bar is 100 μm. FIG. 3J shows a representative true stress-strain curves from a 2D composite scrolled fiber, its polycarbonate (PC) control fiber, and a graphene/PC composite fiber (data reproduced from Science 2016, 353, 364), where the volume fraction of 2DPA-1/PC was 6.9% and graphene/PC was 0.19%. FIG. 3K shows a plot of modulus enhancement ((E−E_{PC})/E_{PC}) against different volume fractions of 2DPA-1.

Chemical kinetic mechanisms of 2D polymerization can be studied. The unique mechanism of 2D polymerization can lead to an understanding methods to increase molecular size and enable variants of additional technological importance. Amorphous, 3D polymers can be the dominant product in such a solution-phase irreversible reaction without specific mechanistic features that favor 2D growth. Two major contributors strongly disfavor 2D growth versus 3D. Firstly, in a situation of homogenous polymerization, all things being equal, the 3D growth rate is much faster than 2D growth. That is because the rate constant is proportional to the number of reaction sites, which grows differently for 2D flakes and 3D beads. Take 3D growth as an example. The rate constant for 3D growth to scale as

$${k}_{Di} \approx {k}_{o} {π ( i )}^{\frac{2}{3}}$$

Meanwhile, for 2D growth, the rate constant is

$${k}_{Di} \approx {k}_{o} {π ( i )}^{\frac{1}{2}}$$

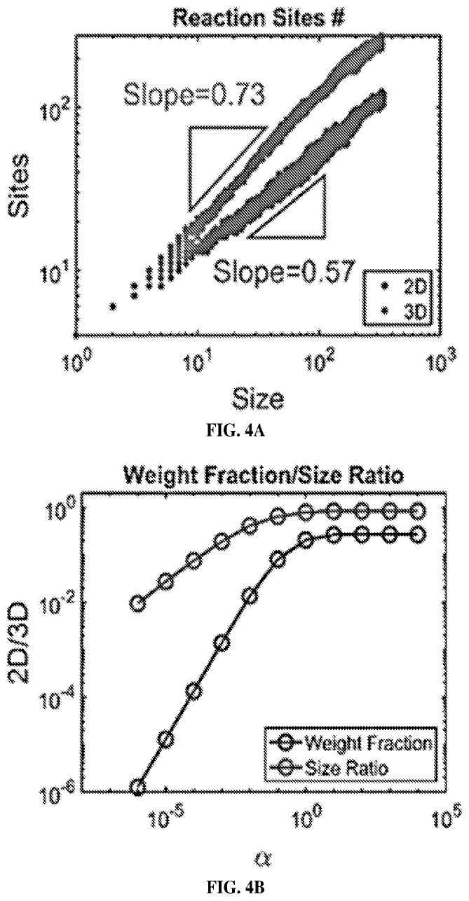

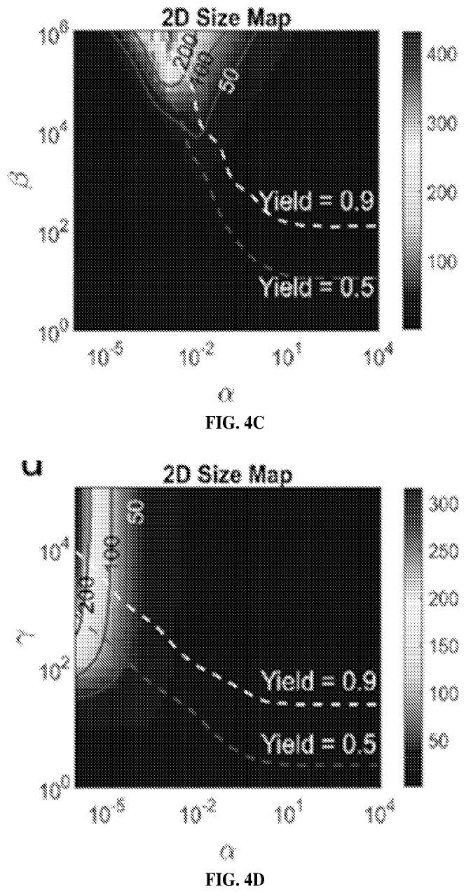

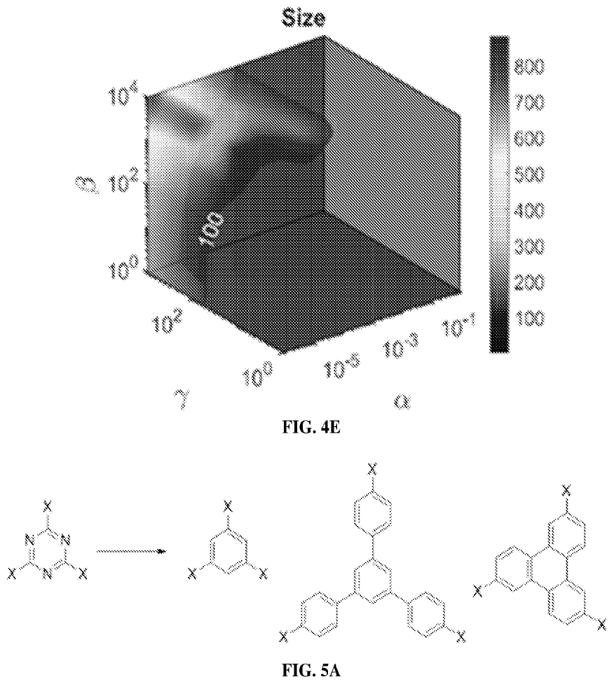

So, if per site addition rate (kₒ) is equal, 3D beads can grow faster with i to the ⅙ power (FIG. 4A).

Secondly, the free rotation of bonds plus an irreversible reaction leads to loss of 2D structure into 3D amorphous products. For a 2D flake, once a reaction site rotates outside of the 2D plane and connects with a monomer, it becomes 3D and can never come back to 2D again.

Two possible mechanisms could effectively suppress out-of-plane defect formation and subsequent 3D growth. One aspect of the reaction that can overcome this limitation is if the 2D material itself can template and catalyze the formation of an adsorbed counterpart. The acceleration may originate from specific interactions such as π-π stacking or interlayer hydrogen bonding that guide the incoming monomers to the exact reaction site in the proper orientation. Here, a factor β can be a free parameter, describing this autocatalytic rate enhancement (FIG. 4C). The other possibility is that linkages may tend to stay in the 2D plane. Thus, the reaction can be entirely different from those reactions with free rotating linkages. In the systems described herein, due to the strong hyperconjugation between the rigid amide bond and adjacent aromatic rings, molecules stay roughly in the plane and favor 2D growth. This effect is parameterized by a factor γ (FIG. 4D). Both mechanisms have been shown to produce 2D polymer with considerable size and yield.

FIG. 4A shows a chemical kinetic theory of 2D polymerization producing 2DPA-1, specifically, predicted reaction site scaling with polymer size (monomer units) for 2D flakes versus 3D beads. FIG. 4B shows a simple 2D growth competing with 3D (defect) growth. Here, α is the normalized monomer activation rate. All rate constants (α, β, γ) are normalized to the per site addition rate (kₒ) and are dimensionless. FIG. 4C shows autotemplating, catalytic 2D growth competing with 3D growth. FIG. 4D shows planar bond 2D growth competing with 3D growth. FIG. 4E shows the combined effect of autocatalytic and planar bond. The bars in FIGS. 4C-4E represent the size of 2D polymers in number of monomers.

To link the model with experimental data, it is possible to use multiple techniques to study the reaction process for 2D polymerization. For example, NMR can determine the fraction of acyl residue groups at various reaction times (FIG. 1I), which could be used to infer the molecular size. The fraction of residue groups reflects the degree of polymerization. As the reaction proceeds, 2D polymers become larger and the fraction of residue groups relative to the reacted groups can drop, which is exactly what was observed in experiments. UV-VIS spectra of the reaction system can be studied to identify the concentration changes of certain species during reaction. The evolution of polymer size, as well as monomer/oligomer concentration determined by the aforementioned methods, could piece together the information for comparison with the model.

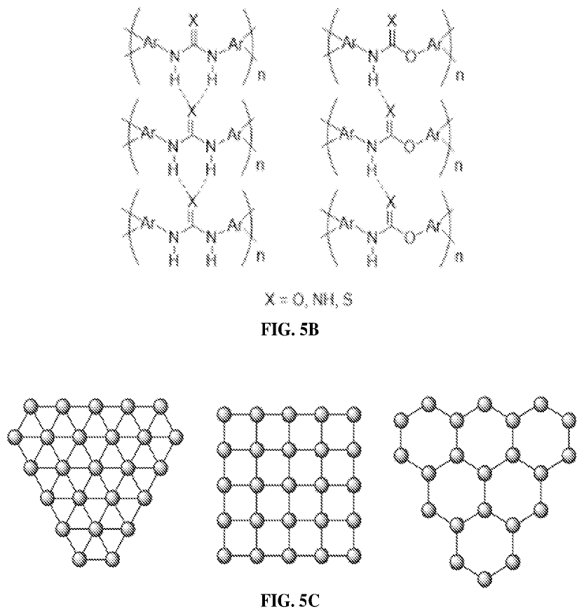

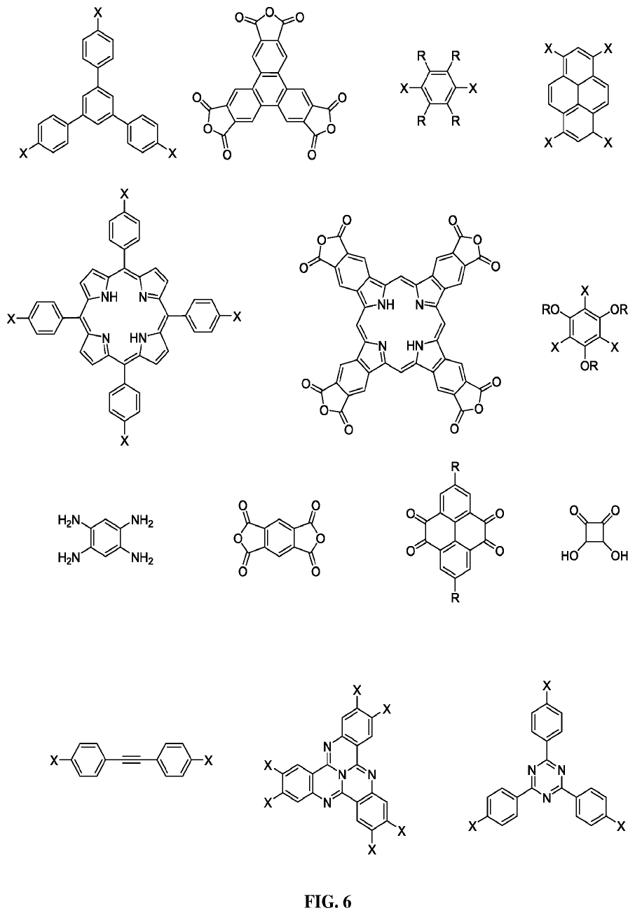

FIGS. 5A-5C show structural variations of 2D polymer motifs now theoretically enabled by the 2DPA-1 synthesis mechanism, referenced herein as variants. FIG. 5A shows exemplary monomer architectures (together with those of FIG. 6). FIG. 5B shows alternative variant linkages capable of hydrogen bonding and autotemplating during synthesis. FIG. 5C shows that variants can control structural topology, including (left to right) triangular, rectilinear, or bi-triangular sub-lattices of 2D polymers.

Additionally, it is possible to increase the size of 2DPA-1 obtained from the reaction. Currently, the average lateral size is around 10 nm. Larger molecules should result in higher mechanical strength of the fabricated material. (Ref. 1) The model predicts that increasing the bond-planarity and autocatalysis effect as much as possible can lead to growth of bigger molecules. The model can further promote the growth (FIG. 4E).

Other irreversible chemistries can perform well under the 2D polymerization mechanism theory described herein. Structural perturbation at the molecular level can influence polymerization and the resulting molecular size and mechanical properties. Generally, the perturbation may originate from one of three parts: monomer chemistry, linkage chemistry, and nanopore topology (FIGS. 5A-5C).

On the monomer side, a large aromatic core reduces the density of interlayer hydrogen bonding while it strengthens the interlayer T-T stacking, therefore changing the mechanical properties of the 2D polymer. In addition, the aromatic core itself may bring some novel optical or electrical responses for potential applications (FIG. 6). For linkages, conjugated chemical bonds can turn the otherwise insulating 2D framework into a conductive one. Alternatively, by switching to other hydrogen bondable linkages, the donor/acceptor abilities can be tuned, which may further increase the material ultimate strength and its flaw tolerance. In addition, a variety of nanopore topologies, from triangles to squares and hexagons, can be constructed based on the monomer building blocks. Those structures possess smaller repeating units that can lead to higher elastic modulus. Also, reduced nanopore size can significantly affect its sieving ability, thus offers new opportunities for materials enabling selective molecular permeability.

FIG. 6 represents monomers for creating structural variants of 2DPA-1 with the goal of controlling internal and intramolecular chemical bonding and relating these features to synthetic and mechanical properties. Monomers lacking the ability for π-π stacking may exclude the autotemplating mechanism. Varying molecular spacing of monomer addition can impact the strength of overlapping out of plane hydrogen bonding, or the elimination of such bonding. The 2D polymer variants can have different bulk 2D polymerization behaviors giving the ability to select one or more polymer properties, including elasticity, chemical resistance, hardness, and the ability to manipulate electrical or thermal properties.

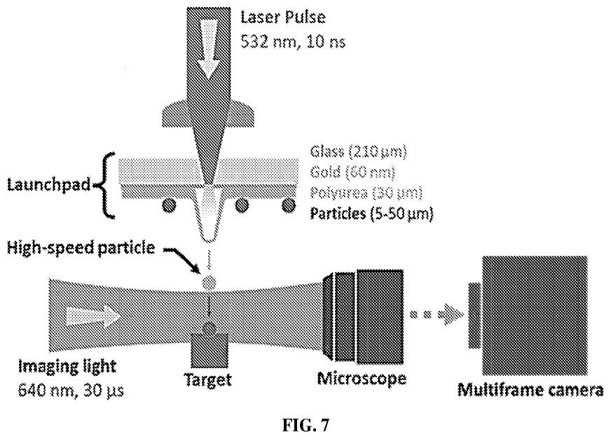

Laser probing of microparticle impact and energy dissipation, such as the specialized laser-based particle impact techniques described in Refs. 16-21, can be used to conduct measurements of high-strain-rate impact in which mitigation and penetration dynamics and energy dissipation can be measured. A laser induced particle impact test (LIPIT) apparatus is illustrated in FIG. 7.

For example, a nanosecond laser pulse (top) ablates a gold film to launch a microparticle toward a target material. The particle flight toward the target and after rebound from or transmission through the target, as well as the impact event, are recorded by a high-speed multi-frame camera. Up to 16 frames can be recorded with as little as 3 ns between frames during a single measurement. The target region to be impacted can be specified to better than 5 micron accuracy, so samples with small lateral dimensions such as thin films supported by TEM grids can be studied.

A nanosecond-duration laser pulse launches a particle of 5-50 micron diameter at a velocity that can be adjusted in approximately the 30-3000 m/s range. The particle may be solid or hollow silica, polymeric, metallic, or other material. Images of the particle traversal toward the target before impact and away from the target after impact yield the incident particle velocity Vᵢ and the transmitted or rebounded velocity Vₜ or Vᵣ, and from the ratio Vᵢ/Vₜ or Vᵢ/Vᵣ (the coefficient of restitution or CoR), the particle kinetic energy dissipated during impact can be determined. In addition, close examination of the impact event itself can reveal intimate details of the particle-sample interaction including thin film distortion and modulations through which energy from the particle is taken up. Post-impact study of impacted samples can reveal long-term deformation caused by the impact, particle embedment, and sample perforation and crack propagation effects, providing detailed information about mitigation and failure mechanisms. The next several figures illustrate some of the important features that can be revealed in LIPIT measurements.

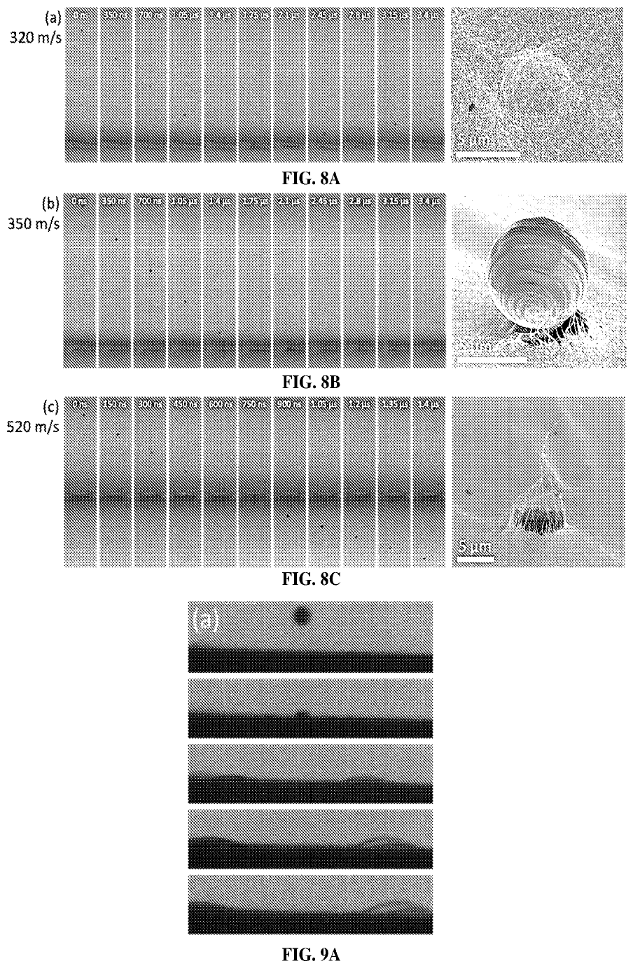

The images in FIGS. 8A-8C show the transition from particle rebound to embedment to perforation as the incident velocity is increased. The particle velocities before and after impact are easily calculated, permitting the coefficient of restitution and the energy absorbed by the sample to be determined in each case. The post-impact SEM images clearly show the different degrees of sample damage resulting from the three impacts.

FIGS. 8A-8C show LIPIT image sequences showing impacts of silica particles (7.4 micron diameter) against films (˜300 nm thickness) consisting of overlapping multi-walled carbon nanotubes, with incident particle velocities of (FIG. 8A) 320 m/s resulting in rebound, (FIG. 8B) 350 m/s resulting in particle capture, and FIG. 8C 520 m/s resulting in perforation. The time at which each image was recorded relative to the first image in the sequence is indicated. The electron microscope images on the right show the sample after impact, revealing (FIG. 8A) sample deformation, (FIG. 8B) the particle and sample damage that it induced, and (FIG. 8C) sample perforation. The images show bottom views of the sample (defining the top as the side that the particles hit).

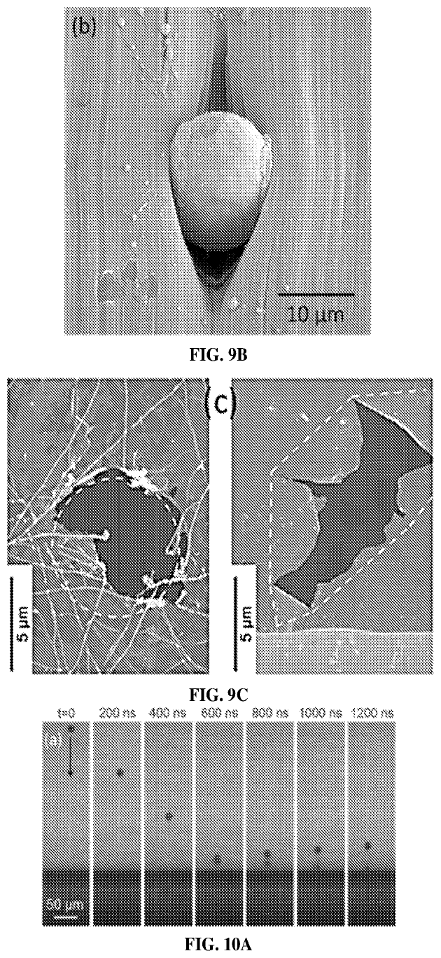

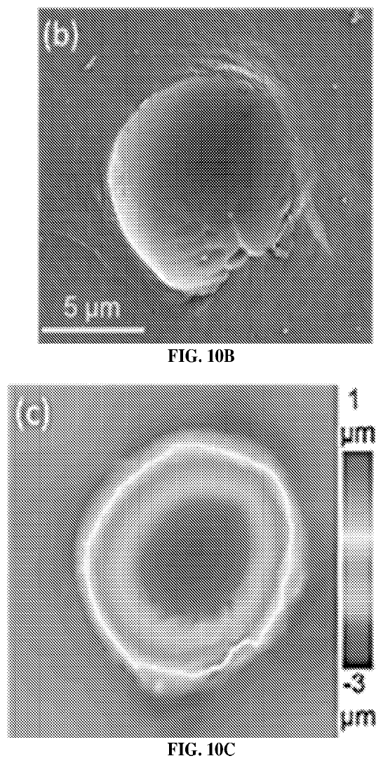

FIGS. 9A-9C show real time and post-impact LIPIT images. FIG. 9A shows real-time images recorded at 200-ns intervals of a 30-μm diameter steel particle impacting a TEFLON-coated fiberglass yarn sample. Part of the impact energy is taken up by propagating acoustic modulations of the sample. FIG. 9B shows a post-impact image following impact at 420 m/s of a 16-μm steel particle that is embedded in an ultrahigh molecular weight polyethylene sample (˜200 μm thick) with highly aligned fibers, showing strongly anisotropic perforation. FIG. 9C shows post-impact images of graphene bilayer samples after penetration by 7.4-μm diameter silica particles at 550 m/s impact velocity. The sample on the left was reinforced by a silver nanowire gridwork that prevented crack propagation which is evident in the un-reinforced sample on the right.

FIGS. 9A-9C illustrate different dynamical and long-lived sample responses to particle impact. The images in FIG. 9A show propagating acoustic responses propagating away from the region of impact, revealing energy uptake into specific dynamical modes of the sample. FIGS. 9B-9C show different types of sample perforation that clearly reveal the effects of sample anisotropy and sample layer reinforcement. Thus, the 2D polymers can have improved properties when combined to form fibrous samples and CNT-reinforced composites.

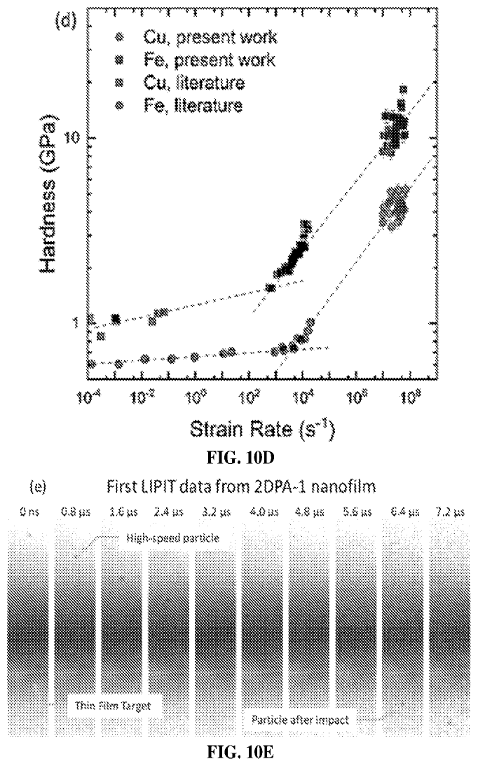

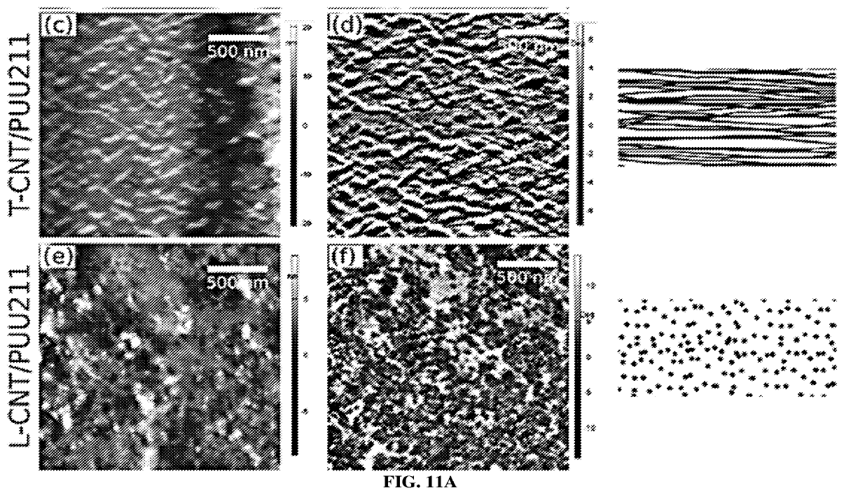

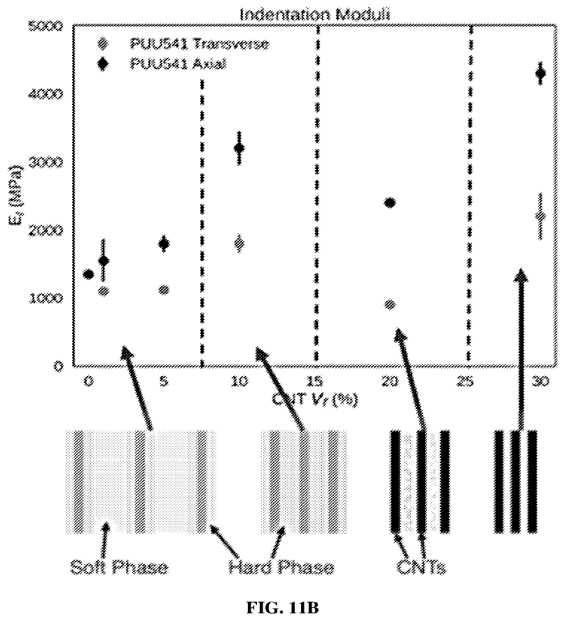

Comparison between high-strain-rate LIPIT results and quasi-static data provide additional insight. FIGS. 10A-10E show the measurement of material hardness at a strain rate in the range of 10⁶ s⁻¹. (Ref. 21) A 14-μm aluminum particle impacts a copper substrate at 425 m/s, leaving a crater after rebounding. The ratio of the energy consumed for the plastic deformation of the substrate, i.e. the plastic work, to the total impact energy is deduced directly from the image sequence as W_{plastic}/E_{impact}=1−(Vᵣ/Vᵢ)², and the dynamic hardness is given by the ratio of the plastic work to the indentation volume:

$$Hardness = \frac{{W}_{plastic}}{{V}_{indent}} = \frac{{(}^{1} {/}_{2} ) \times {m}_{p} \times ( {V}_{i}^{2} - {V}_{r}^{2} )}{{V}_{indent}}$$

$$where$$

$${m}_{p} is the particle mass .$$

The indentation volume can be measured through laser confocal imaging. The results show far higher hardness at high strain rates than at low rates. Similar measurements on the 2D polymer samples by rolling the 2D polymer into “scrolls” that are sufficiently thick that they can respond to microparticle impact as essentially bulk samples. Comparison to quasi-static measurements can show substantial frequency-dependent variation in hardness due to the polymer degrees of freedom with nonlinear relaxation kinetics in the intermediate frequency ranges.

FIG. 10A shows real-time images of a 14-μm diameter alumina particle impacting a copper substrate at 425 m/s. FIG. 10B shows a crater left in copper substrate after particle impact and rebound. FIG. 10C shows a confocal microscope image used to determine crater volume. FIG. 10D shows results showing dynamic hardness of copper and iron samples, with comparison to hardness values at lower strain rates. (Ref. 21). FIG. 10E shows a LIPIT image sequence showing a 7.4-μm silica particle penetrating a 2DPA-1 film (˜ 30 nm thick). The sample is mounted on a TEM grid and the particle is aimed at a grid opening. The incident particle speed was 62 m/s, resulting in perforation with a residual velocity of 55 m/s. The coefficient of restitution was 0.89 for this impact. FIG. 10E the first LIPIT images showing particle impact on a 30-nm thick 2DPA-1 film which is mounted on a TEM grid. A region of the sample over a grid opening was targeted.

The LIPIT measurements for the compositions described herein include variation in incident particle velocity and observation of the transition between particle rebound and transmission so that close-up real-time observation of impact events can be conducted. For very thin layers, hollow silica particles can be the preferred choice because low particle density and mass as well as relatively low velocity can allow the full range of CoR values to be measured from particle rebound to penetration conditions. The observations reveal sample layer distortion and displacement, and particle breakthrough when it occurs, allowing determination of sample strain distributions, crack propagation, and other features that guide modeling and synthesis refinements.

The 2D polymer variations can form a composite including a nanofiber reinforcement (carbon nanotubes, CNTs, are examples) in both random and aligned orientations particularly for high packing fraction nanocomposites. Nanostructure process-structure-property relations and linking to molecular and mechanistic understanding can inform selection of monomer for specific applications and achieving high strain rate properties.

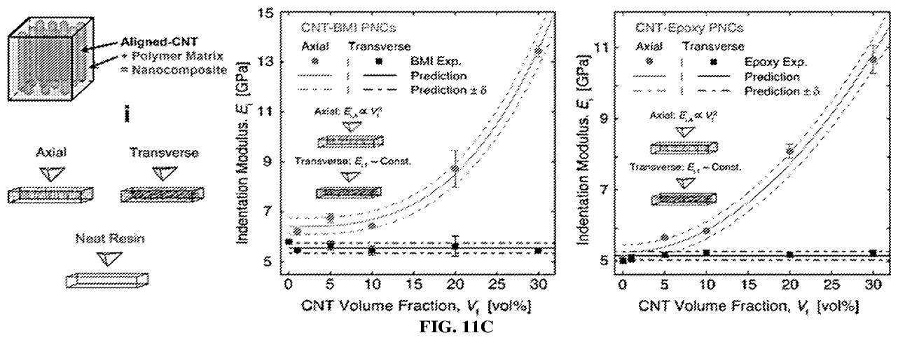

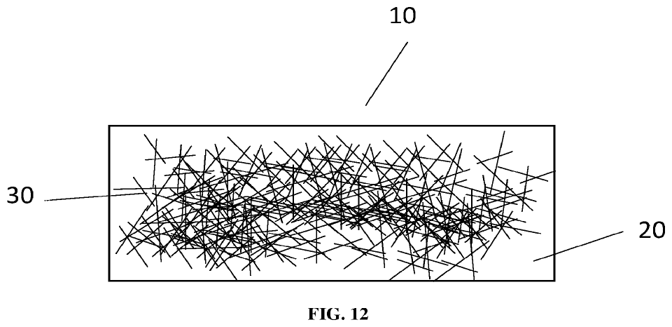

FIGS. 11A-11C show textured polymer nanocomposite mechanical properties obtained via scanning probe AFM and nanoindentation. FIG. 11A shows 2D AFM scans of polyurethane-urea with dense packing of aligned CNTs in the longitudinal and transverse directions showing both texture and phase segregation within the PUU with (left) height, (center) phase, (right) CNT orientation. (Ref. 22) FIG. 11B shows PUU nanocomposite modulus scaling explained by phase separation morphogenesis as CNT packing fraction increases. (Ref. 23) FIG. 11C shows nanoindentation results for anisotropic modulus in aerospace-grade thermosets (bismaleimide-BMI, and epoxy). (Ref. 24)

Referring to FIG. 12, a composite 10 can include a two dimensional polymer 20 and reinforcement material 30.

Nanostructured composites including 2DP and variations described herein and hard nanostructures can be synthesized, and the nanocomposites can be characterized, for example, for structure and tested mechanically to compare to neat 2DP. Additional comparisons to other materials of interest, such as PC and graphene used currently, can be made. A hard nanostructure including carbon nanotubes (CNTs), a 1D material that is of significant interest, can be prepared. This can include processing in ways to achieve texture and thus anisotropic properties. (Refs. 25-27) In addition to these fibrous forms of carbon, graphene nanoplatelets (GNP) may also be studied selectively for comparison. CNTs and GNP are compatible with the 2DP processing, particularly the current TFA solvent (Ref. 28). Other materials for composites can include alumina nanotubes (ANTs), which can be synthesized via ALD and thermal decomposition. (Ref. 29) Characterization can center on thick-film techniques, to complement the thin-film work to date (see FIGS. 4A-4E), including scanning-probe AFM (such as Veeco Nanoscope) and nanoindentation. These techniques offer both anisotropic mechanical data (with appropriate known specimen preparation) and the ability to contribute structural understanding as well using contact mode AFM, and connect hardness and modulus at low-strain to the high-strain tests. Recent examples of such work have enabled discovery of unique PUU-derived hard and soft segment features formed within nm-scale CNT constraints (Refs. 22 and 23) and other successful process-structure-property studies (Ref. 24). The real-time imaging can directly reveal the energy dissipation properties of the various composites, and the post-impact imaging capabilities (as in FIGS. 8A-8C and 9A-9C) can reveal important details of particle-sample interactions. LIPIT results should reveal the effects of CNT packing fraction on impact energy dissipation and perforation-induced sample damage (as in FIGS. 8A-9C) as well as the effects of nanofiber alignment on the anisotropy of nonlinear mechanical responses (as in FIG. 9B).

The nanocomposites can be synthesized following the known routes and compatibilities of the 2DP processing. Currently, the 2DP is deposited as a thin film by dissolving 2DP in TFA, suggesting two useful and complementary compositing strategies: (i) adding randomly-oriented CNTs to the 2DP-TFA solution pre-casting, and (ii) depositing the 2DP on CNTs pre-dispersed on the substrate as a thin film. The latter can be done for both horizontally-aligned CNTs (Ref. 30) and randomly-aligned CNTs to look at texture and confinement effects. The extent of texturing can be studied as a function of CNT vol % and 2DP film thickness, and the process can be repeated to create a layered nanocomposite. The influence of CNTs on the 2DP structure can provide insights into how long-range order of the 2DP may be extended even further and can be evaluated by 3D TEM and diffraction techniques. Routes to understand hard nanostructure effects on the in situ polymerization can also be studied. Possibilities include physically dispersing CNTs at varying concentrations in the pre-polymer solution to assess effects on 2DP formation, and also exploring capillary infusion of the pre-polymer solution into arrays of CNTs (again, at various CNT concentrations or vol %) to study textured nm-scale constraint effects, similar to those studied recently for phenolic-derived carbon-matrix nanocomposites (Refs. 31 and 32) and formation of polyelectrolyte bi-layers (Ref. 33). Other nanocomposite architectures can be prepared, such as 2DP-TFA solution infusion into variable (controlled) volume-fraction A-CNT forests to explore this type of nanocomposite compared to the layered thick films. Scrolled fiber mechanical testing or micro-computed tomography (μCT) can be employed for process quality assessment and control.

Advantageously, chemical kinetic study of 2DPA-1 can show in-plane polymerization, allowing prediction of final molecular size, LIPIT measurements on 2DPA-1 can include particle composition and velocity range to complete the first full LIPIT study of 2DPA-1, and nanocomposites, such as 2D polymer/CNT composites, can include fabrication to high packing fraction (>30 vol %) 2D polymer/CNT with variable alignment. In certain circumstances, 2DPA-1 polymerization can lead to molecular sizes exceeding 100 nm. Chemical kinetic study of triphenyl benzene and other variant monomers, for example, those shown in FIG. 6, can generate the 2DPA-1 variants.

References (identified as “Ref. #” above, each of which is incorporated by reference in its entirety):
1 Sandoz-Rosado, E. et al. “High strength films from oriented, hydrogen-bonded “graphamid” 2D polymer molecular ensembles”. Sci Rep-Uk 8, (2018).
2 Gee, G. “Reactions in monolayers of drying oils II-Polymerization of the oxidized forms of the maleic anhydride compound of β-elacostearin”. Proceedings of the Royal Society of London. Series A-Mathematical and Physical Sciences 153, 129-141, (1935).
3 Gee, G. et al. “Reaction in monolayers of drying oils I-The oxidation of the maleic anhydride compound of B-Elaeostearin”. Proceedings of the Royal Society of London. Series A-Mathematical and Physical Sciences 153, 116-128, (1935).
4 Stupp, S. I. et al. “Synthesis of two-dimensional polymers”. Science 259, 59-63, (1993).
5 Hiroyuki Ozaki, M. K., Takao Tsuchiya, Tsutomu Funaki, Yasuhiro Mazaki, Masaru Aoki, Shigeru Masuda, Yoshiya Harada. “Formation of atomic cloth observed by Penning ionization electron spectroscopy”. J Chem Phys 103, 1226-1228, (1995).
6 Kissel, P. et al. “A two-dimensional polymer prepared by organic synthesis”. Nat Chem 4, 287-291, (2012).
7 Cote, A. P. et al. “Porous, crystalline, covalent organic frameworks”. Science 310, 1166-1170, (2005).
8 Berlanga, I. et al. “Delamination of layered covalent organic frameworks”. Small 7, 1207-1211, (2011).
9 Kandambeth, S. et al. “Covalent Organic Frameworks: Chemistry beyond the Structure”. J Am Chem Soc 141, 1807-1822, (2019).
10 Zhang, B. et al. “Crystalline Dioxin-Linked Covalent Organic Frameworks from Irreversible Reactions”. J Am Chem Soc 140, 12715-12719, (2018).
11 Guan, X. et al. “Chemically stable polyarylether-based covalent organic frameworks”. Nat Chem 11, 587-594, (2019).
12 Cai, Z. et al. “Chemical Vapor Deposition Growth and Applications of Two-Dimensional Materials and Their Heterostructures”. Chem Rev 118, 6091-6133, (2018).
13 Lee, C. et al. “Measurement of the elastic properties and intrinsic strength of monolayer graphene”. Science 321, 385-388, (2008).
14 Castellanos-Gomez, A. et al. “Elastic properties of freely suspended MoS₂ nanosheets”. Adv Mater 24, 772-775, (2012).
15 Sakamoto, J. et al. “Two-Dimensional Polymers: Just a Dream of Synthetic Chemists?”. Angewandte Chemie International Edition 48, 1030-1069, (2009).
16 Sun, Y. C. et al. “Molecular dependencies of dynamic stiffening and strengthening through high strain rate microparticle impact of polyurethane and polyurea elastomers”. Appl Phys Lett 115, (2019).
17 Veysset, D. et al. “Molecular influence in high-strain-rate microparticle impact response of poly(urethane urea) elastomers”. Polymer 123, 30-38, (2017).
18 Lienhard, J. et al. “Surface oxide and hydroxide effects on aluminum microparticle impact bonding”. Acta Mater 197, 28-39, (2020).
19 Shieh, P. et al. “Cleavable comonomers enable degradable, recyclable thermoset plastics”. Nature 583, 542-+, (2020).
20 Veysset, D. et al. “High-Strain-Rate Behavior of a Viscoelastic Gel Under High-Velocity Microparticle Impact”. Exp Mech 60, 1179-1186, (2020).
21 Hassani, M. et al. “Material hardness at strain rates beyond 10 (6) s(−1) via high velocity microparticle impact indentation”. Scripta Mater 177, 198-202, (2020).
22 Gair, J. L. et al. “Strong process-structure interaction in stoveable poly(urethane-urea) aligned carbon nanotube nanocomposites”. Compos Sci Technol 166, 115-124, (2018).
23 Gair Jr, J. L. “Nanotube-Matrix Interplay and Tunability in Ultrahigh Volume-Fraction Aligned Carbon Nanotube Poly (Urethane-urea) Nanocomposites” Ph.D. thesis, University of Maryland, College Park, (2017).
24 Kaiser, A. L. “Interfacial and physical confinement effects on the structure and properties of aligned carbon nanotube architectures” Ph.D. thesis, Massachusetts Institute of Technology, (2021).
25 Wardle, B. L. et al. “Fabrication and characterization of ultrahigh-volume-fraction aligned carbon nanotube-polymer composites”. Advanced Materials 20, 2707-+, (2008).
26 Natarajan, B. et al. “Aligned carbon nanotube morphogenesis predicts physical properties of their polymer nanocomposites”. Nanoscale 11, 16327-16335, (2019).
27 Natarajan, B. et al. “The Evolution of Carbon Nanotube Network Structure in Unidirectional Nanocomposites Resolved by Quantitative Electron Tomography”. Acs Nano 9, 6050-6058, (2015).
28 Acauan, L. H. et al. “Multifunctional nanocomposite structural separators for energy storage”. Nanoscale 11, 21964-21973, (2019).
29 Chen, H. et al. “Dispersion of carbon nanotubes and polymer nanocomposite fabrication using trifluoroacetic acid as a co-solvent”. Nanotechnology 18, (2007).
30 Lee, J. et al. “Impact of carbon nanotube length on electron transport in aligned carbon nanotube networks”. Appl Phys Lett 106, (2015).
31 Vanderhout, A. R. “Synthesis and mechanical characterization of aligned carbon nanotube metal-and carbon-matrix nanocomposites”, Massachusetts Institute of Technology, (2020).
32 Stein, I. Y. et al. “Mesoscale evolution of non-graphitizing pyrolytic carbon in aligned carbon nanotube carbon matrix nanocomposites”. J Mater Sci 52, 13799-13811, (2017).
33 Yost, A. L. et al. “Layer-by-layer functionalized nanotube arrays: A versatile microfluidic platform for biodetection”. Microsyst Nanoeng 1, (2015).

Details of one or more embodiments are set forth in the accompanying drawings and description. Other features, objects, and advantages will be apparent from the description, drawings, and claims. Although a number of embodiments of the invention have been described, it will be understood that various modifications may be made without departing from the spirit and scope of the invention. It should also be understood that the appended drawings are not necessarily to scale, presenting a somewhat simplified representation of various features and basic principles of the invention.

What is claimed is:

1. A composition comprising a two dimensional polymer derived from at least: 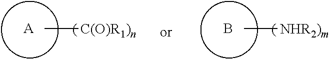
wherein R₁ is a leaving group and R₂ is H or C1-C6 alkyl, n is 2, 3, 4 or 5, m is 3, 4 or 5, and at least one of the A ring and the B ring is, independently, a planar symmetric ring.

2. The composition of claim 1, wherein n is 3 and m is 3, n is 2 and m is 3, n is 3 and m is 2, n is 4 and m is 2, or n is 2 and m is 4.

3. The composition of claim 1, wherein n is 3, m is 3, and the two dimensional polymer includes a structure 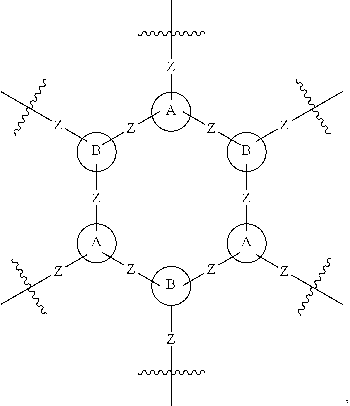
wherein each Z is an amide, urea, or carbamate linkage.

4. The composition of claim 1, wherein R₂ is H.

5. A composition comprising a two dimensional polymer derived from one or more of the following planar building blocks: 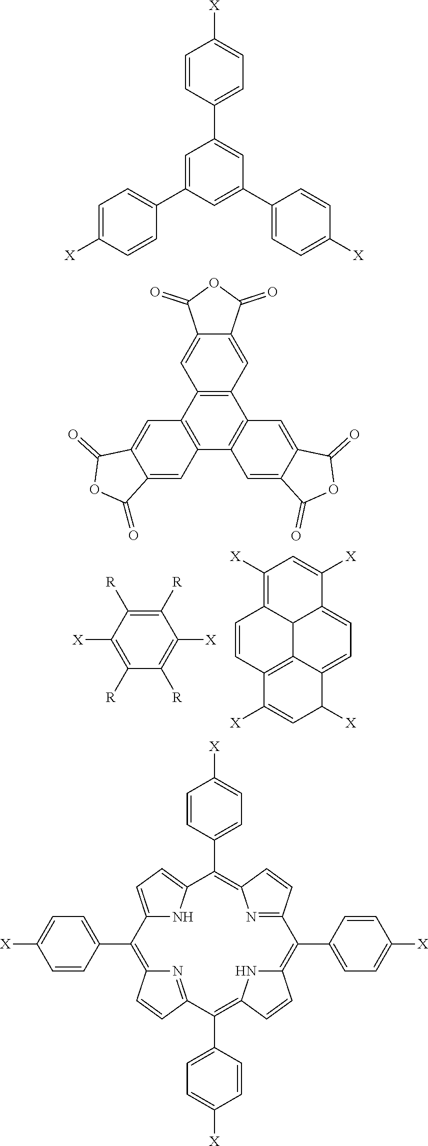 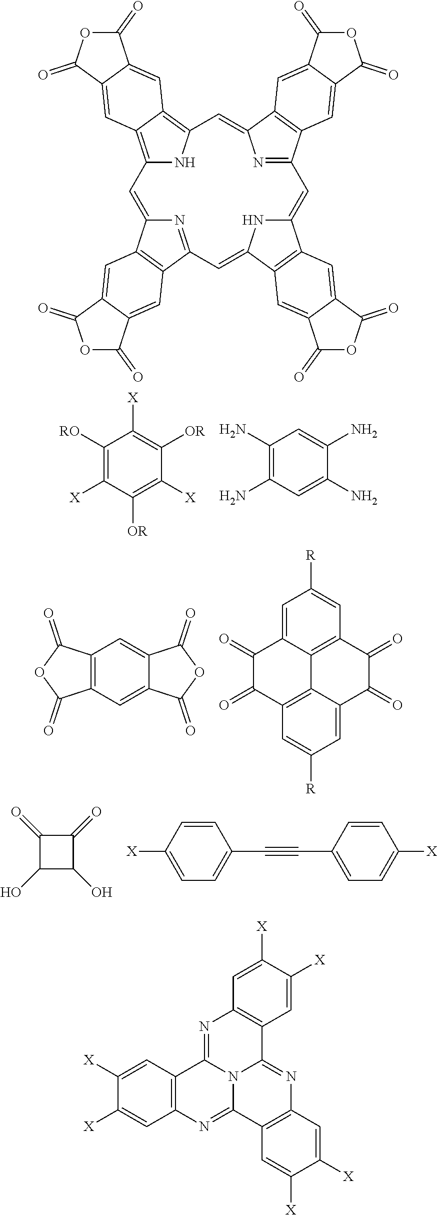 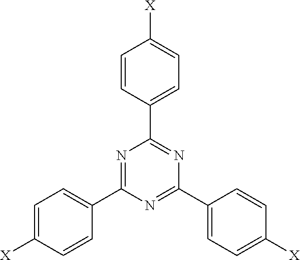
wherein each R, independently is H, C1-C6 acyl or C1-C6 alkyl and each X is an amino group, hydroxyl group, carboxyl group, anhydride group, or isocyanate group, wherein the X groups, anhydride groups or carbonyl groups of the building blocks bond to a polyamine building block to form the two dimensional polymer.

6. The composition of claim 5, wherein the polyamine building block includes a planar amine including at least three amine groups each of which forms an amide bond with one of the planar building blocks to form the two dimensional polymer.

7. The composition of claim 5, wherein the planar amine includes a tri-amino aryl group.

8. The composition of claim 7, wherein the aryl is a carbocyclic aromatic or a heterocyclic aromatic.

9. The composition of claim 8, wherein the carbocyclic aromatic is phenyl, naphthyl, antrhracenyl, phenanthrenyl, chrysenyl, pyrenyl, corannulenyl, triphenyl benzene, or coronenyl.

10. The method of claim 8, wherein the heterocyclic aromatic is pyridinyl, pyrimidinyl, triazinyl, pteridinyl, or a porphyrin.

11. The composition of claim 5, wherein the planar building block includes

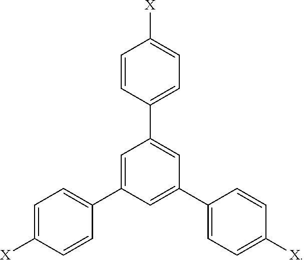

12. The composition of claim 5, wherein the planar building block includes

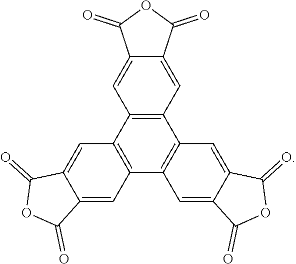 [SMILES: O=c1oc(=O)c2cc3c(cc12)c1cc2c(=O)oc(=O)c2cc1c1cc2c(=O)oc(=O)c2cc31]

13. The composition of claim 5, wherein the planar building block includes

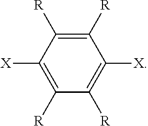

14. The composition of claim 5, wherein the planar building block includes

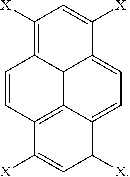

15. The composition of claim 5, wherein the planar building block includes

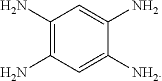

16. The composition of claim 5, wherein the planar building block includes

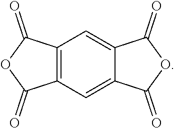 [SMILES: O=c1oc(=O)c2cc3c(=O)oc(=O)c3cc12]

17. The composition of claim 5, wherein the planar building block includes

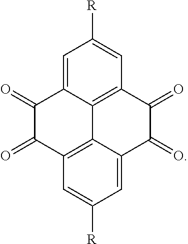

18. The composition of claim 5, wherein the planar building block includes

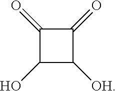

19. The composition of claim 5, wherein the planar building block includes

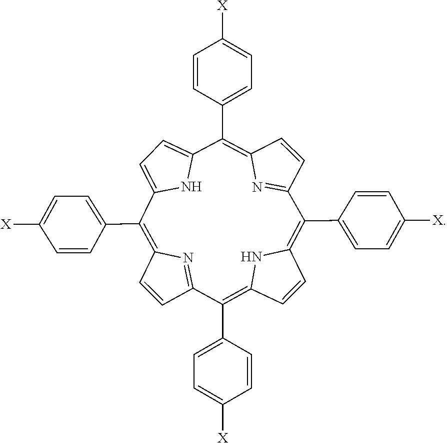

20. The composition of claim 5, wherein the planar building block includes

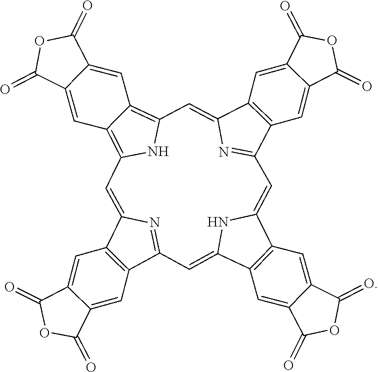 [SMILES: O=C1OC(=O)c2cc3c(cc21)-c1cc2[nH]c(cc4nc(cc5[nH]c(cc-3n1)c1cc3c(cc51)C(=O)OC3=O)-c1cc3c(cc1-4)C(=O)OC3=O)c1cc3c(cc21)C(=O)OC3=O]

21. The composition of claim 5, wherein the planar building block includes

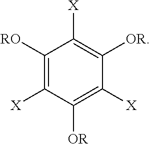

22. The composition of claim 5, wherein the planar building block includes

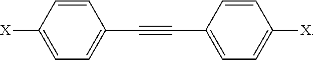

23. The composition of claim 5, wherein the planar building block include

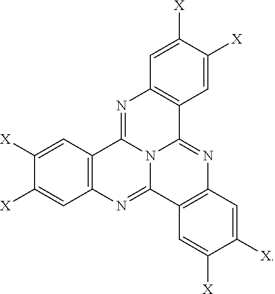

24. The composition of claim 5, wherein the planar building block includes

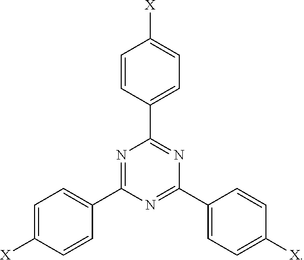

25. A method of manufacturing a composition of any one of claims 1-24, comprising combining a planar building block with a polyamine building block to form the two dimensional polymer.

26. A method of forming a coating of a two dimensional polymer comprising depositing a composition of any one of claims 1-24 on a surface.

27. A composite comprising a composition of any one of claims 1-24 and a reinforcement material.

28. The composite of claim 27, wherein the reinforcement material includes a nanomaterial.

29. The composite of claim 28, wherein the nanomaterial is a carbon nanotube, a graphene platelet or an alumina nanotube.

30. The composite of claim 27, wherein the reinforcement material is graphene or carbon fiber.

31. The composite of claim 27, wherein the reinforcement material is aligned.

32. The composite of claim 27, wherein the composite is anisotropic.

33. A method of making a composite of any one of claims 27-32, comprising combining a two dimensional polymer with a reinforcement material.

34. The method of claim 33, wherein the reinforcement material is dispersed with a pre-polymer solution composed to form the two dimensional polymer.

35. The method of claim 33, wherein a pre-polymer solution composed to form the two dimensional polymer is infused into the reinforcement material prior to polymerization.

36. The method of claim 33, wherein the two dimensional polymer is infused into an arrangement of the reinforcement material.

37. The method of claim 36, wherein the arrangement of the reinforcement material includes aligned fibers or nanotubes.

38. The method of claim 36, wherein the arrangement of the reinforcement material includes randomly oriented fibers or nanotubes.
